(19) United States
(12) Patent Application Publication
(10) Pub. No.: US 2026/0214709 A1
(43) Pub. Date: Jul. 23, 2026

(54) WIRELESS COMMUNICATION CONTROL APPARATUS, WIRELESS COMMUNICATION CONTROL METHOD, AND PROGRAM

(71) Applicant: Sony Group Corporation, Tokyo (JP)

(72) Inventors: Shigeru SUGAYA, Tokyo (JP); Yusuke TANAKA, Tokyo (JP); Yuichi MORIOKA, Tokyo (JP); Kosuke AIO, Tokyo (JP); Ryuichi HIRATA, Tokyo (JP)

(73) Assignee: Sony Group Corporation, Tokyo (JP)

(21) Appl. No.: 19/135,835

(22) PCT Filed: Dec. 27, 2023
(86) PCT No.: PCT/JP2023/046884

§ 371 Date: Jun. 5, 2025

(30) Foreign Application Priority Data
Jan. 13, 2023 (JP) 2023-003582

(51) Int. Cl. H04W 74/0816; H04W 74/00; H04W 80/02

(52) U.S. Cl. CPC H04W 74/0816; H04W 74/002; H04W 80/02

(57) ABSTRACT

The present technology relates to a wireless communication control apparatus, a wireless communication control method, and a program that are capable of ensuring high reliability of wireless communication when a non-legacy apparatus and a legacy apparatus are mixed.

A transmission controller controls transmission of a frame in which RTS information as legacy information for a legacy apparatus and allocation information as non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame. The present technology is applicable to, for example, a wireless communication module included in a wireless communication apparatus of a wireless communication system that performs RTA data communication using the R-TWT technology.

### TECHNICAL FIELD

The present technology relates to a wireless communication control apparatus, a wireless communication control method, and a program, and particularly to, a wireless communication control apparatus, a wireless communication control method, and a program that are capable of ensuring high reliability of wireless communication when a non-legacy apparatus and a legacy apparatus are mixed.

### BACKGROUND ART

Currently, an increase in the amount of transmission data is expected in applications that transmit data in conformity to the Institute of Electrical and Electronics Engineers (IEEE) 802.11be standard. Further, it is also expected that low latency and high reliability are required for the transmission.

In this regard, the restricted target wakeup time (R-TWT) technology is being considered in the IEEE802.11be standardization. The TWT technology is a technology of activating a target at a predetermined time to achieve a low-power consumption operation. The R-TWT technology is a technology of applying the TWT technology for a wireless communication apparatus to periodically acquire transmission opportunities (TXOP) and then preferentially transmit data to be transmitted with low latency in those transmission opportunities over other data.

In this R-TWT technology, data for real-time applications that request low latency transmission can be preferentially transmitted over other data. Therefore, the R-TWT technology is seen as a promising technology of performing transmission in real-time applications.

Meanwhile, in conventional wireless communication apparatuses, the Request to Send (RTS)/Clear to Send (CTS) technology has been widely used. The RTS/CTS technology is a technology that declares the use of a transmission path to surrounding wireless communication apparatuses by exchanging RTS and CTS frames prior to data transmission between wireless communication apparatuses that transmit and receive data, and causes the wireless communication apparatuses to set a network allocation vector (NAV). This allows the surrounding wireless communication apparatuses to refrain from performing transmission during a data transmission/reception period for predetermined wireless communication apparatuses, so that the predetermined wireless communication apparatuses can reliably transmit and receive data.

The operation of describing the stipulation of a quiet period in the beacon of an access point (AP) and transmitting it and then causing stations (STAs) connected to the AP to refrain from transmitting data in a certain period is an optional standard. However, stations that constitute overlapping basic service sets (OBSS) do not recognize the quiet period unless they are implemented to support this optional standard.

There is a wireless communication apparatus that receives a frame for requesting a TWT operation, and when it is determined that the frame is the frame for low-latency communication having periodicity, performs a predetermined notification to limit the time length of the frame transmitted by a wireless communication apparatus different from the wireless communication apparatus that has transmitted this frame (see, for example, Patent Literature 1).

### Citation List

### Patent Literature

Patent Literature 1: Japanese Patent Application Laid-open No. 2022-133131

### DISCLOSURE OF INVENTION

### Technical Problem

When wireless communication is performed using a new technology such as the R-TWT technology, existing wireless communication apparatuses that are not compatible with the new technology may impair the reliability of the wireless communication. For example, a legacy apparatus serving as a wireless communication apparatus that cannot interpret a predetermined type of media access control (MAC) frame used in the new technology may impair the reliability of the wireless communication using the new technology.

Therefore, there is a need to provide a method of ensuring the high reliability of wireless communication when a non-legacy apparatus, which is a wireless communication apparatus capable of interpreting a predetermined type of MAC frame used in the new technology, and a legacy apparatus are mixed, but such a need has not been sufficiently met.

The present technology has been made in view of the circumstances as described above, and can ensure the high reliability of wireless communication when a non-legacy apparatus and a legacy apparatus are mixed.

### Solution to Problem

A wireless communication control apparatus or a program of a first aspect of the present technology is a wireless communication control apparatus including a transmission controller that controls transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame, or a program for causing a computer to function as a wireless communication control apparatus.

A wireless communication control method of a first aspect of the present technology is a wireless communication control method including a transmission control step of controlling, by a wireless communication control apparatus, transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

In the first aspect of the present technology, transmission of a frame in which legacy information for a legacy apparatus and non-legacy information for a non-legacy apparatus are disposed in association with each other is controlled, the legacy apparatus being a wireless communication apparatus that is unable to interpret a predetermined type of MAC frame, the non-legacy apparatus being a wireless communication apparatus that is able to interpret the predetermined type of MAC frame.

A wireless communication control apparatus or a program of a second aspect of the present technology is a wireless communication control apparatus including a reception controller that controls reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame, or a program for causing a computer to function as a wireless communication control apparatus.

A wireless communication control method of a second aspect of the present technology is a wireless communication control method including a reception control step of controlling, by a wireless communication control apparatus, reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

In the second aspect of the present technology, reception of a frame in which legacy information for a legacy apparatus and non-legacy information for a non-legacy apparatus are disposed in association with each other is controlled, the legacy apparatus being a wireless communication apparatus that is unable to interpret a predetermined type of MAC frame, the non-legacy apparatus being a wireless communication apparatus that is able to interpret the predetermined type of MAC frame.

The wireless communication control apparatus may be an independent apparatus or may be a module incorporated in another apparatus.

### BRIEF DESCRIPTION OF DRAWINGS

FIG. 1 is a diagram showing a configuration example of a first embodiment of a wireless communication system to which the present technology is applied.

FIG. 2 is a block diagram showing a configuration example of a non-legacy apparatus.

FIG. 3 is a block diagram showing a configuration example of a wireless communication module.

FIG. 4 is a flowchart for describing real-time parameter exchange processing in the first embodiment.

FIG. 5 is a diagram showing an example of a data structure of a setup request element.

FIG. 6 is a flowchart for describing real-time parameter setting processing.

FIG. 7 is a timing chart showing an example of a communication operation performed using the R-TWT technology without considering a legacy apparatus.

FIG. 8 is a timing chart for describing an example of a communication operation for RTA data of FIG. 7.

FIG. 9 is a timing chart showing an example of a communication operation using the R-TWT technology in the first embodiment.

FIG. 10 is a timing chart for describing a communication operation for RTA data of FIG. 9.

FIG. 11 is a flowchart for describing RTA data communication processing in the first embodiment.

FIG. 12 is a diagram showing an example of a data structure of a trigger frame.

FIG. 13 is a diagram showing a first configuration example of an RTS trigger frame.

FIG. 14 is a diagram showing an example of a data structure of a CF-END frame.

FIG. 15 is a flowchart for describing RTS trigger frame transmission processing.

FIG. 16 is a flowchart for describing RTA data transmission processing in the first embodiment.

FIG. 17 is a flowchart for describing RTA data reception processing in the first embodiment.

FIG. 18 is a diagram showing a second configuration example of the RTS trigger frame.

FIG. 19 is a diagram showing a third configuration example of the RTS trigger frame.

FIG. 20 is a diagram showing a fourth configuration example of the RTS trigger frame.

FIG. 21 is a diagram showing a fifth configuration example of the RTS trigger frame.

FIG. 22 is a flowchart for describing real-time parameter exchange processing in a second embodiment.

FIG. 23 is a timing chart for describing another example of a communication operation for RTA data of FIG. 7.

FIG. 24 is a timing chart showing an example of a communication operation using the R-TWT technology in the second embodiment.

FIG. 25 is a timing chart for describing a communication operation for RTA data of FIG. 24.

FIG. 26 is a flowchart for describing RTA data communication processing in the second embodiment.

FIG. 27 is a diagram showing a first configuration example of a CTS trigger frame.

FIG. 28 is a flowchart for describing CTS trigger frame transmission processing.

FIG. 29 is a flowchart for describing RTA data transmission processing in the second embodiment.

FIG. 30 is a flowchart for describing RTA data reception processing in the second embodiment.

FIG. 31 is a diagram showing a second configuration example of the CTS trigger frame.

FIG. 32 is a diagram showing a third configuration example of the CTS trigger frame.

FIG. 33 is a diagram showing a fourth configuration example of the CTS trigger frame.

FIG. 34 is a diagram showing a fifth configuration example of the CTS trigger frame.

FIG. 35 is a block diagram showing a hardware configuration example of a computer.

FIG. 36 is a block diagram showing a schematic configuration example of a smartphone to which the present technology is applied.

FIG. 37 is a block diagram showing a schematic configuration example of an in-vehicle apparatus to which the present technology is applied.

FIG. 38 is a block diagram showing a schematic configuration example of a wireless AP to which the present technology is applied.

### MODE(S) FOR CARRYING OUT THE INVENTION

Hereinafter, modes for carrying out the present technology (hereinafter, referred to as embodiments) will be described. Note that the description will be given in the following order.
1. First Embodiment (Communication System to Transmit RTS Trigger Frame)
2. Second Embodiment (Communication System to Transmit CTS Trigger Frame)
3. Computer
4. Smartphone
5. In-Vehicle Apparatus
6. Wireless AP

### 1. First Embodiment

### Configuration Example of Wireless Communication System

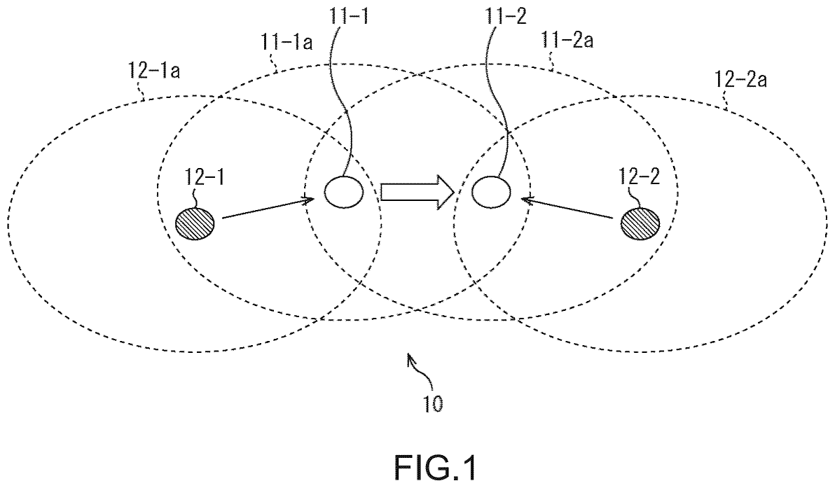

FIG. 1 is a diagram showing a configuration example of a first embodiment of a wireless communication system to which the present technology is applied.

As shown in FIG. 1, a wireless communication system 10 is configured by connecting non-legacy apparatuses 11-1 and 11-2 and legacy apparatuses 12-1 and 12-2 via a wireless local area network (LAN).

The non-legacy apparatuses 11-1 and 11-2 are wireless communication apparatuses each capable of interpreting a trigger frame serving as a predetermined type of MAC frame used in the R-TWT technology. The non-legacy apparatus 11-1 transmits RTA data, which is data to be transmitted with low latency used in the real time application (RTA), to the non-legacy apparatus 11-2 located in a communicable range (radio wave range) 11-1a by using the R-TWT technology. The non-legacy apparatus 11-2 receives the RTA data transmitted from the non-legacy apparatus 11-1 located in a communicable range 11-2a.

In the example of FIG. 1, for example, one of the non-legacy apparatuses 11-1 and 11-2 operates as an access point, and the other one of them operates as a station, to constitute one basic service set (BSS), but the non-legacy apparatuses 11-1 and 11-2 are not limited to this configuration. For example, both of the non-legacy apparatuses 11-1 and 11-2 may operate as stations.

Note that the non-legacy apparatuses 11-1 and 11-2 will be hereinafter referred to collectively as a non-legacy apparatus 11 if there is no need to distinguish between the non-legacy apparatus 11-1 and the non-legacy apparatus 11-2. Similarly, the communicable ranges 11-1a and 11-2a will be referred to collectively as a communicable range 11a.

The legacy apparatuses 12-1 and 12-2 are wireless communication apparatuses that are unable to interpret trigger frames. The legacy apparatus 12-1 is a wireless communication apparatus that constitutes an overlapping BSS (OBSS) in which the non-legacy apparatus 11-1 is located in a communicable range 12-1a. The legacy apparatus 12-2 is a wireless communication apparatus that constitutes an OBSS in which the non-legacy apparatus 11-2 is located in a communicable range 12-2a. Both the legacy apparatus 12-1 and the non-legacy apparatus 11-2 can communicate with the non-legacy apparatus 11-1, but are in a relationship of hidden terminals where they cannot communicate with each other. Both the legacy apparatus 12-2 and the non-legacy apparatus 11-1 can communicate with the non-legacy apparatus 11-2, but are in a relationship of hidden terminals where they cannot communicate with each other.

Note that the legacy apparatuses 12-1 and 12-2 will be hereinafter referred to collectively as a legacy apparatus 12 if there is no need to distinguish between the legacy apparatus 12-1 and the legacy apparatus 12-2. Similarly, the communicable ranges 12-1a and 12-2a will be referred to collectively as a communicable range 12a.

### Configuration Example of Non-Legacy Apparatus

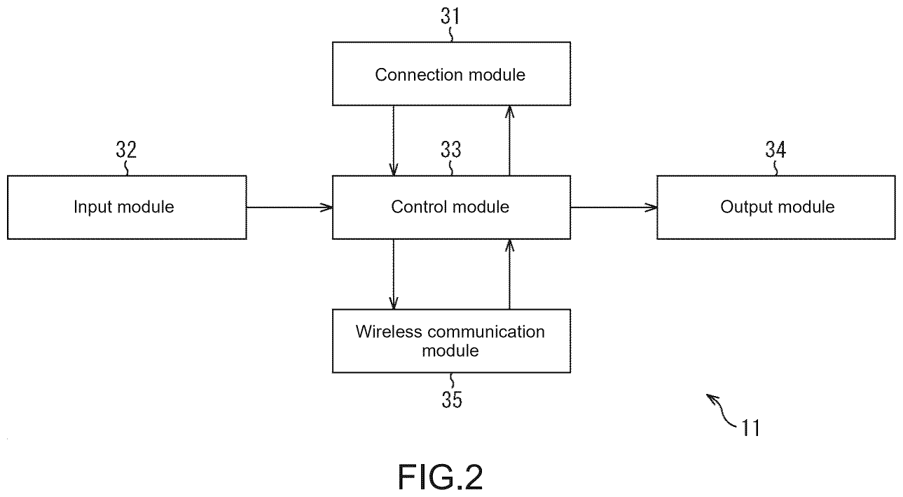

FIG. 2 is a block diagram showing a configuration example of the non-legacy apparatus 11 of FIG. 1.

In the example of FIG. 2, the non-legacy apparatus 11 includes a connection module 31, an input module 32, a control module 33, an output module 34, and a wireless communication module 35. Note that the non-legacy apparatus 11 only needs to include the control module 33 and the wireless communication module 35, and the connection module 31, the input module 32, and the output module 34 may not be provided as necessary or may be simplified.

The connection module 31 is, for example, a module that is necessary when the non-legacy apparatus 11 operates as an access point. The connection module 31 includes a communication modem or the like for connecting to an Internet network, and provides Internet connection via a public communication line and an Internet service provider. The connection module 31 supplies data received via the Internet to the control module 33. The connection module 31 transmits the data supplied from the control module 33 via the Internet.

The input module 32 includes an operation button, a keyboard, a touch panel, and the like. The input module 32 accepts operations from the user and supplies instructions corresponding to the operations to the control module 33.

The control module 33 controls the whole of the non-legacy apparatus 11. For example, the control module 33 acquires the data supplied from the connection module 31 or supplies data to the connection module 31 for transmission via the Internet. The control module 33 makes various settings on the basis of instructions supplied from the input module 32. The control module 33 supplies the operating state of the non-legacy apparatus 11 and the data supplied from the connection module 31 to the output module 34 for output. The control module 33 acquires the data supplied from the wireless communication module 35 or supplies data to the wireless communication module 35 for transmission by wireless communication. The control module 33 allows the user's desired non-legacy apparatus 11 to operate as an access point, for example.

The output module 34 includes a display section such as a light emitting diode (LED) panel, a liquid crystal panel, or an organic electro luminescence (EL) display, a speaker for outputting sound and music, and the like. For example, the output module 34 displays an image corresponding to the operating state, data, etc. of the non-legacy apparatus 11 supplied from the control module 33 and outputs sound.

The wireless communication module 35 functions as a wireless communication control apparatus that uses the R-TWT technology to perform wireless communication with other non-legacy apparatuses 11 and legacy apparatuses 12 located in the communicable range 11a via a wireless LAN. Specifically, the wireless communication module 35 transmits data supplied from the control module 33 to other non-legacy apparatuses 11 and legacy apparatuses 12. The wireless communication module 35 receives data transmitted from other non-legacy apparatuses 11 and legacy apparatuses 12 and supplies the data to the control module 33.

### Configuration Example of Wireless Communication Module

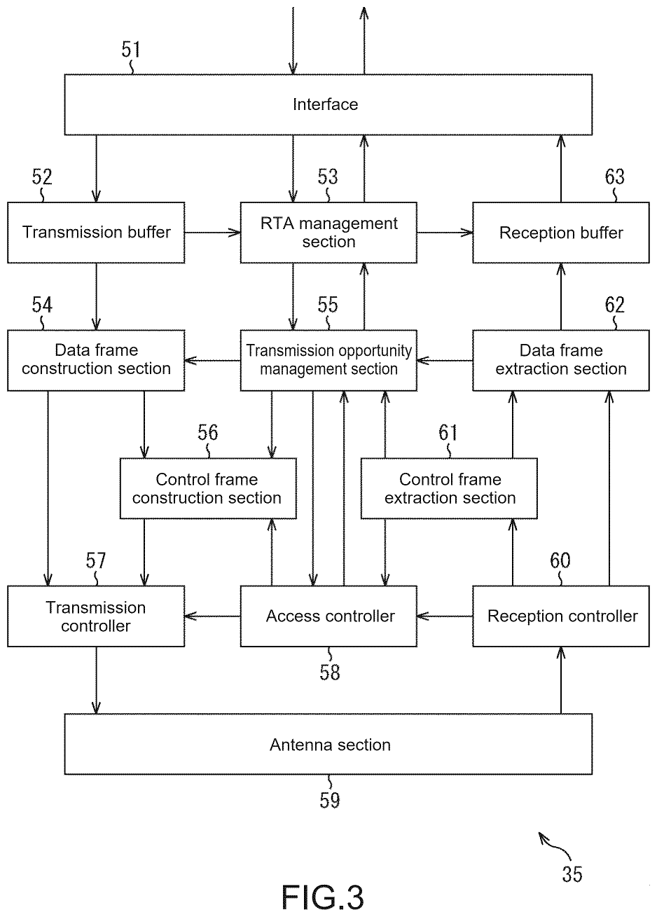

FIG. 3 is a block diagram showing a configuration example of the wireless communication module 35 of FIG. 2.

The wireless communication module 35 of FIG. 3 includes an interface 51, a transmission buffer 52, an RTA management section 53, a data frame construction section 54, a transmission opportunity management section 55, a control frame construction section 56, a transmission controller 57, an access controller 58, and an antenna section 59. The wireless communication module 35 further includes a reception controller 60, a control frame extraction section 61, a data frame extraction section 62, and a reception buffer 63.

The interface 51 is connected to the control module 33 of FIG. 2 and exchanges various types of information and data with the control module 33. The interface 51 supplies the transmission data supplied from the control module 33 to the transmission buffer 52. The interface 51 exchanges various types of information with the RTA management section 53. The interface 51 supplies reception data supplied from the reception buffer 63 to the control module 33.

The transmission buffer 52 temporarily stores the transmission data supplied from the interface 51. When storing RTA data as the transmission data, the transmission buffer 52 notifies the RTA management section 53 of the presence of RTA data. The transmission buffer 52 supplies the stored transmission data to the data frame construction section 54.

The RTA management section 53 manages the RTA data by exchanging various types of information with the interface 51 and by referring to notifications supplied from the transmission buffer 52. For example, the RTA management section 53 instructs the reception buffer 63 to output the reception data stored therein to the interface 51. The RTA management section 53 exchanges various types of information with the transmission opportunity management section 55 while estimating real-time parameters that can be executed.

The data frame construction section 54 constructs a data frame of the transmission data supplied from the transmission buffer 52 at a predetermined timing under the instruction of the transmission opportunity management section 55. A data frame is one of the types of MAC frames specified in IEEE802.11. A MAC frame is a MAC protocol data unit (MPDU) consisting of a MAC header and data. The data frame construction section 54 supplies the data frame to the transmission controller 57. The data frame construction section 54 supplies a notification relating to the data frame to the control frame construction section 56.

The transmission opportunity management section 55 manages an R-TWT service point (SP) while exchanging information with the RTA management section 53, exchanging real-time parameters with the access controller 58, and referring to information from the control frame extraction section 61 and notifications from the data frame extraction section 62. Specifically, the transmission opportunity management section 55 sets real-time parameters. Note that the R-TWT SP is a transmission opportunity for periodically transmitting RTA data using the R-TWT technology. The real-time parameters are access control parameters relating to the R-TWT SP.

Since the amount of RTA data to be transmitted in an R-TWT SP period is variable, the R-TWT SP period is set to be a period corresponding to the maximum value assumed as that amount of data. For example, for uplink communication of RTA data, a non-legacy apparatus 11 operating as an access point needs to receive a Buffer Status Report in advance to know the amount of data stored in the transmission buffer 52 of a non-legacy apparatus 11 operating as a station. If the non-legacy apparatus 11 operating as an access point does not know that amount of data, it fails to calculate a parameter such as the time required for uplink communication. Further, the status of the transmission buffer 52 of the non-legacy apparatus 11 operating as a station constantly changes. Therefore, the R-TWT SP period is set to be a period corresponding to the maximum value assumed as the amount of RTA data to be transmitted in the R-TWT SP period.

The transmission opportunity management section 55 instructs the data frame construction section 54 to construct a data frame at a predetermined timing on the basis of the R-TWT SP. The transmission opportunity management section 55 instructs the control frame construction section 56 to construct a control frame at a predetermined timing on the basis of the R-TWT SP. A control frame is one of the types of MAC frames specified in IEEE 802.11.

The control frame construction section 56 constructs a control frame such as an RTS trigger frame at a predetermined timing on the basis of the instruction from the transmission opportunity management section 55 and the notifications from the data frame construction section 54 and the access controller 58. An RTS trigger frame is a control frame in which RTS information included in an RTS frame and allocation information (trigger information) included in a trigger frame are disposed in association with each other. The RTS information is one of the legacy information for the legacy apparatus 12, which can be interpreted by both the non-legacy apparatus 11 and the legacy apparatus 12. The allocation information is non-legacy information for the non-legacy apparatus 11, which can be interpreted only by the non-legacy apparatus 11, and includes information indicating resource allocation or the like for RTA data. The control frame construction section 56 supplies the control frame to the transmission controller 57.

The transmission controller 57 performs encoding and other processing on the data frame from the data frame construction section 54, the control frame from the control frame construction section 56, and a management frame from the access controller 58 to generate encoded data. A management frame is one of the types of MAC frames specified in IEEE802.11. The transmission controller 57 controls the transmission of the encoded data by supplying the encoded data to the antenna section 59 at a predetermined timing on the basis of an instruction by the access controller 58.

The access controller 58 generates a management frame including the real-time parameters supplied from the RTA management section 53 via the transmission opportunity management section 55 and supplies the management frame to the transmission controller 57. The access controller 58 supplies the real-time parameters supplied from the reception controller 60 to the RTA management section 53 via the transmission opportunity management section 55.

The access controller 58 performs access control necessary for transmission of encoded data by inputting instructions to the transmission controller 57 on the basis of a notification regarding the status of the transmission path supplied from the reception controller 60 and information supplied from the control frame extraction section 61. Thus, the notification regarding the status of the transmission path from the reception controller 60 is input to the access controller 58. This allows the access controller 58 to monitor the status of the transmission path sequentially. Therefore, the access controller 58 can transmit the encoded data more suitable for the status of the transmission path by inputting an instruction to the transmission controller 57 on the basis of this notification.

The antenna section 59 transmits the radio signals of encoded data supplied from the transmission controller 57. The antenna section 59 receives (detects) radio signals of encoded data of the data frames, the control frames, and the management frames transmitted from other non-legacy apparatuses 11 and legacy apparatuses 12, and supplies the encoded data to the reception controller 60.

The reception controller 60 controls the reception of encoded data by the antenna section 59. The reception controller 60 performs decoding or the like on the encoded data supplied from the antenna section 59 to extract MAC frames such as a data frame, a control frame, and a management frame. The reception controller 60 supplies the control frame to the control frame extraction section 61, the data frame to the data frame extraction section 62, and the real-time parameters included in the management frame to the access controller 58. The reception controller 60 provides a notification regarding the status of the transmission path to the access controller 58 on the basis the encoded data supplied from the antenna section 59.

The control frame extraction section 61 extracts information included in the control frame such as an RTS trigger frame supplied from the reception controller 60. The control frame extraction section 61 supplies that information to the transmission opportunity management section 55, the data frame extraction section 62, and the access controller 58 as necessary.

The data frame extraction section 62 extracts the transmission data such as RTA data included in the data frame supplied from the reception controller 60, as reception data, and supplies it to the reception buffer 63. The data frame extraction section 62 supplies a notification regarding the reception data to the transmission opportunity management section 55.

The reception buffer 63 temporarily stores the reception data supplied from the data frame extraction section 62. The reception buffer 63 outputs the stored reception data to the interface 51 in response to an instruction from the RTA management section 53.

### Description of Real-Time Parameter Exchange Processing

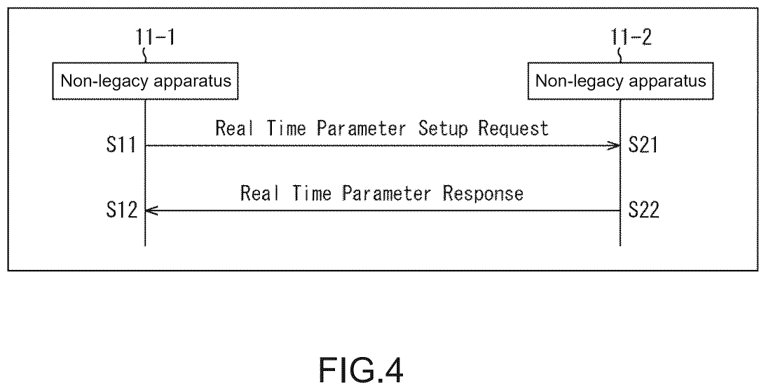

FIG. 4 is a flowchart for describing real-time parameter exchange processing that is performed between the non-legacy apparatuses 11-1 and 11-2 to exchange real-time parameters.

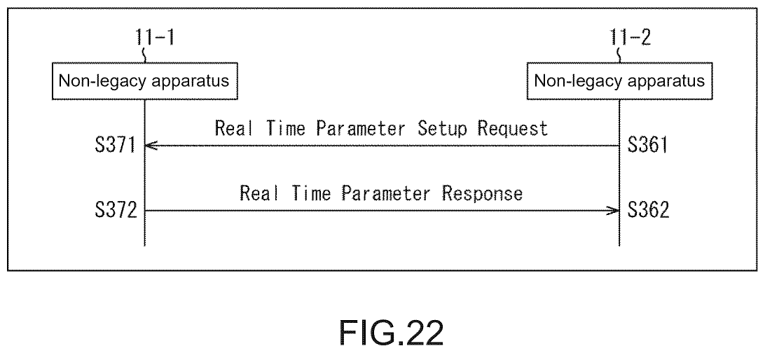

The real-time parameter exchange processing starts, for example, when an association is performed between the non-legacy apparatuses 11-1 and 11-2. This is also the case in FIG. 22 to be described below.

In Step S11 of FIG. 4, the transmission controller 57 of the non-legacy apparatus 11-1 transmits encoded data of a Real Time Parameter Setup Request frame via the antenna section 59. The Real Time Parameter Setup Request frame is a management frame that includes a setup request element for which real-time parameters are set. The real-time parameters are calculated by the RTA management section 53 and the transmission opportunity management section 55 and supplied to the transmission controller 57 via the access controller 58.

In Step S21, the reception controller 60 of the non-legacy apparatus 11-2 receives the Real Time Parameter Setup Request frame transmitted by the processing of Step S11 via the antenna section 59. The reception controller 60 supplies the real-time parameters included in that Real Time Parameter Setup Request frame to the transmission opportunity management section 55 and the RTA management section 53 via the access controller 58. On the basis of those real-time parameters, the transmission opportunity management section 55 sets adaptable real-time parameters. The transmission opportunity management section 55 supplies the set real-time parameters to the transmission controller 57 via the access controller 58.

In Step S22, the transmission controller 57 transmits encoded data of a Real Time Parameter Response frame that is a management frame including a setup response element for which those real-time parameters are set, via the antenna section 59.

In Step S12, the reception controller 60 receives the Real Time Parameter Setup Response frame transmitted by the processing of Step S22 via the antenna section 59. The reception controller 60 supplies the real-time parameters included in the Real Time Parameter Setup Request frame to the transmission opportunity management section 55 via the access controller 58. On the basis of those real-time parameters, the transmission opportunity management section 55 sets real-time parameters. The real-time parameter exchange processing then ends.

The agreed-upon real-time parameters between the non-legacy apparatuses 11-1 and 11-2 are shared in the real-time parameter exchange processing of FIG. 4.

### Example of Data Structure of Setup Request Element

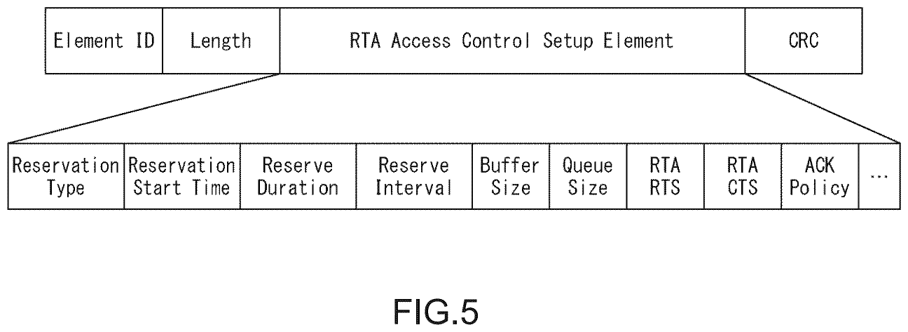

FIG. 5 is a diagram showing an example of a data structure of the setup request element included in the Real Time Parameter Setup Request frame.

The setup request element of FIG. 5 is an element that requests the setting of real-time parameters and is a type of information element. This setup request element includes Element ID indicating the format of this element, Length indicating the information length of this element, RTA Access Control Setup Element as actual data, and CRC as an error detection code. Note that the CRC may not be included.

For the RTA Access Control Setup Element, real-time parameters set by the transmission opportunity management section 55, that is, desired parameters of the transmission side of the Real Time Parameter Setup Request frame are set.

Specifically, in the RTA Access Control Setup Element, Reservation Type as an identifier of an R-TWT SP setting method, Reservation Start Time indicating the start time of the R-TWT SP, and Reserve Duration indicating the time of the R-TWT SP are disposed. In the RTA Access Control Setup Element, Reserve Interval indicating the intervals between R-TWT SP cycles, Buffer Size indicating the size of the buffer, and Queue Size indicating the queue size of the buffer are also disposed. In the RTA Access Control Setup Element, RTA RTS indicating whether or not RTS trigger frames can be interpreted, and RTA CTS indicating whether or not CTS trigger frames in a second embodiment to be described below can be interpreted are also disposed. Further, in the RTA Access Control Setup Element, ACK Policy indicating whether to return a block ACK (Acknowledgement) frame (hereinafter, referred to as a BA frame), which is one type of MAC frame, and the like are disposed.

Note that the configuration of the setup response element included in the Real Time Parameter Setup Response frame is the same as the configuration of the setup request element of FIG. 5, and thus the description thereof will be omitted. The setup response element is an element that returns real-time parameters, and the real-time parameters that the transmission source of this element can support are set for the RTA Access Control Setup Element.

### Description of Real-Time Parameter Setting Processing

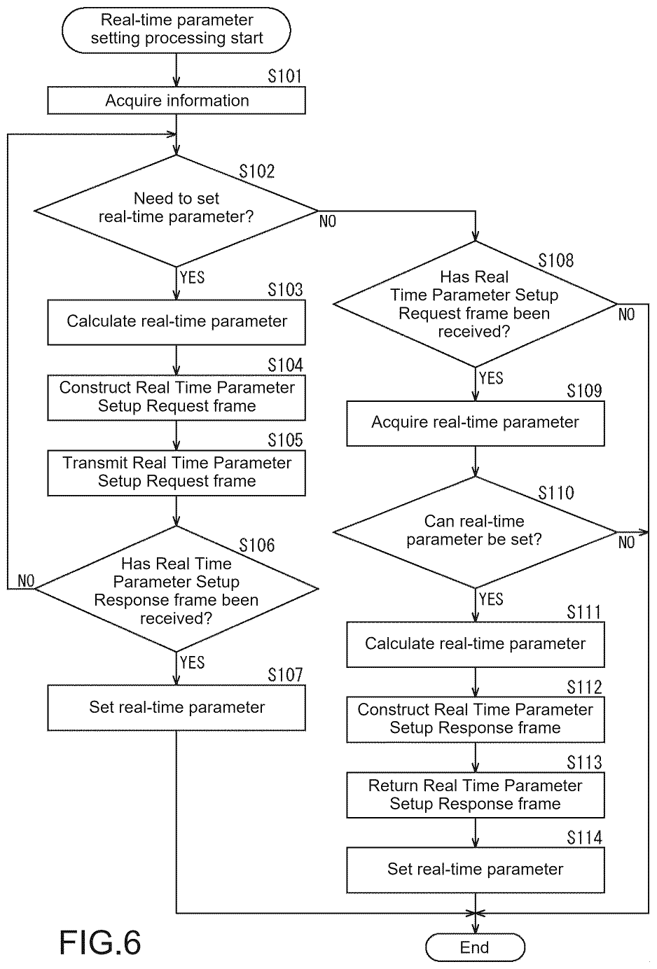

FIG. 6 is a flowchart for specifically describing the processing of each non-legacy apparatus 11 in the real-time parameter exchange processing of FIG. 4 as real-time parameter setting processing.

In Step S101, the RTA management section 53 and the transmission opportunity management section 55 acquire information necessary for setting a real-time application, such as the amount of data that can be transmitted per predetermined time, information on the maximum allowable delay, and the capacity of the transmission buffer 52 or reception buffer 63 available for RTA data.

In Step S102, the non-legacy apparatus 11 determines whether to need to set real-time parameters. If it is determined in Step S102 that real-time parameters need to be set, the processing proceeds to Step S103.

In Step S103, the RTA management section 53 and the transmission opportunity management section 55 calculate real-time parameters on the basis of the information acquired in Step S101 and supply the real-time parameters to the access controller 58.

In Step S104, the access controller 58 constructs a Real Time Parameter Setup Request frame for which the real-time parameters calculated in Step S103 have been set, and supplies it to the transmission controller 57.

In Step S105, the transmission controller 57 performs encoding or the like on the Real Time Parameter Setup Request frame constructed in Step S104 and transmits the resulting encoded data to another non-legacy apparatus 11 via the antenna section 59.

In Step S106, the reception controller 60 determines whether or not encoded data of a Real Time Parameter Setup Response frame returned from the other non-legacy apparatus 11 has been received via the antenna section 59 within a predetermined time.

If it is determined in Step S106 that the encoded data of the Real Time Parameter Setup Response frame has been received, the reception controller 60 supplies real-time parameters included in that Real Time Parameter Setup Response frame to the access controller 58. Those real-time parameters are supplied to the transmission opportunity management section 55, and the processing proceeds to Step S107.

In Step S107, the transmission opportunity management section 55 sets the real-time parameters supplied from the access controller 58 and terminates the real-time parameter setting processing.

On the other hand, if it is determined in Step S106 that the Real Time Parameter Setup Response frame has not been received, the processing returns to Step S102, and the subsequent processing is repeated. Thus, for example, the real-time parameters are calculated again, and the encoded data of the Real Time Parameter Setup Request frame is transmitted again.

If it is determined in Step S102 that real-time parameters do not need to be set, the processing proceeds to Step S108. In Step S108, the reception controller 60 determines whether or not the encoded data of the Real Time Parameter Setup Request frame has been received from another non-legacy apparatus 11 via the antenna section 59.

If it is determined in Step S108 that the encoded data of the Real Time Parameter Setup Request frame has been received, the reception controller 60 supplies the real-time parameters included in the Real Time Parameter Setup Request frame to the access controller 58. Those real-time parameters are supplied to the RTA management section 53 via the transmission opportunity management section 55, and the processing proceeds to Step S109.

In Step S109, the transmission opportunity management section 55 and the RTA management section 53 acquire the real-time parameters supplied from the access controller 58. In Step S110, the transmission opportunity management section 55 and the RTA management section 53 determine whether or not real-time parameters corresponding to the real-time parameters acquired in Step S109 can be set on the basis of the information acquired in Step S101.

If it is determined in Step S110 that real-time parameters can be set, the processing proceeds to Step S111. In Step S111, the RTA management section 53 and the transmission opportunity management section 55 calculate the real-time parameters that they can support on the basis of the information acquired in Step S101 and the real-time parameters acquired in Step S109, and supply the real-time parameters to the access controller 58.

In Step S112, the access controller 58 constructs a Real Time Parameter Setup Response frame for which the real-time parameters calculated in Step S111 have been set, and supplies it to the transmission controller 57.

In Step S113, the transmission controller 57 performs encoding or the like on the Real Time Parameter Setup Response frame constructed in Step S112, and returns the resulting encoded data via the antenna section 59.

In Step S114, the transmission opportunity management section 55 sets the real-time parameters calculated in Step S111 and terminates the real-time parameter setting processing.

On the other hand, if it is determined in Step S108 that the encoded data of the Real Time Parameter Setup Request frame has not been received, the real-time parameter setting processing is terminated. If it is determined in Step S110 that the real-time parameters cannot be set, the real-time parameter setting processing is terminated.

### Description of Example of Communication Operation Performed Using R-TWT Technology Without Considering Legacy Apparatus

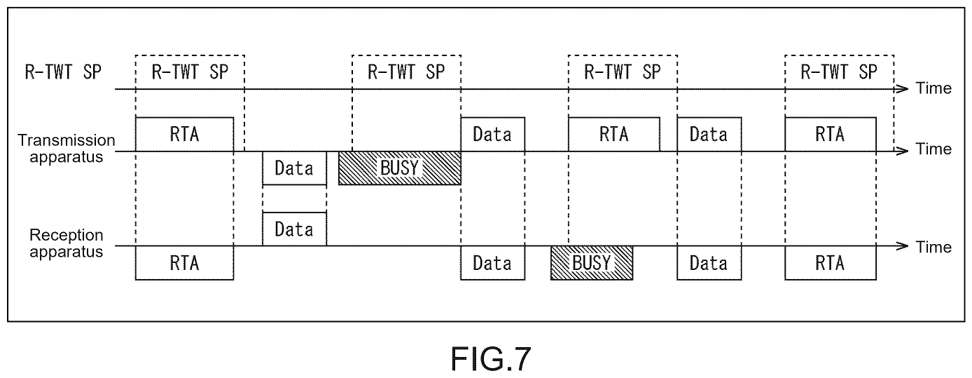

FIG. 7 is a timing chart showing an example of a communication operation performed using the R-TWT technology without considering the legacy apparatus.

The upper row of FIG. 7 indicates the period of the R-TWT SP set in advance. The middle row indicates an operation of a transmission apparatus, which is a non-legacy apparatus that acquires an R-TWT SP and transmits RTA data. The lower row indicates an operation of a reception apparatus, which is a non-legacy apparatus that receives the RTA data. In the middle and lower rows, the transmitting operation is indicated to be convex upward, and the receiving operation is indicated to be convex downward. The horizontal axis of FIG. 7 represents time.

As shown by the dotted-line rectangle in the upper row of FIG. 7, the R-TWT SP period is set in a substantially periodic manner. Within the R-TWT SP period, the transmission apparatus preferentially transmits the RTA data with a specific identifier TID. Outside the R-TWT SP period, any wireless communication apparatus can transmit and receive any data.

Therefore, as shown in the middle row of FIG. 7, for example, the transmission apparatus transmits the RTA data to the reception apparatus in the first R-TWT SP period. As shown in the lower row of FIG. 7, the reception apparatus receives that RTA data from the transmission apparatus.

After the end of the first R-TWT SP period, the reception apparatus transmits data other than the RTA data to the transmission apparatus as shown in the lower row of FIG. 7. The transmission apparatus receives that data from the reception apparatus as shown in the middle row of FIG. 7.

The transmission apparatus wants to transmit RTA data also in the second R-TWT SP period in the same way as in the first R-TWT SP period. However, for example, legacy apparatuses located in the OBSS do not understand the communication protocol for RTA data using the R-TWT technology, and thus they start communication regardless of the R-TWT SP period when they determine that the state of the transmission path is free. Therefore, for example, if the legacy apparatuses are communicating within the second R-TWT SP period, the transmission apparatus is in a BUSY state and is not able to transmit RTA data, as shown in the middle row of FIG. 7.

After the end of the BUSY state, the transmission apparatus can transmit RTA data. However, as shown in the middle row of FIG. 7, if the BUSY state does not end within the second R-TWT SP period, the transmission apparatus may be unable to transmit RTA data that is planned to be transmitted in the second R-TWT SP period. In other words, outside of the R-TWT SP period, any wireless communication apparatus transmits any data after implementing access control, and thus the transmission of the RTA data from the transmission apparatus is not always given priority.

In the example of FIG. 7, after the end of the BUSY state, the transmission apparatus transmits data other than the RTA to the reception apparatus as shown in the middle row of FIG. 7, and the reception apparatus receives that data from the transmission apparatus as shown in the lower row of FIG. 7.

After that, as shown in the middle row of FIG. 7, the transmission apparatus transmits the RTA data in the third R-TWT SP period in the same way as in the first R-TWT SP period. At that time, for example, if a legacy apparatus located in the OBSS transmits data to the reception apparatus and the reception apparatus is receiving strong radio waves of the data, it is difficult for the reception apparatus to accurately decode the encoded data of the RTA data transmitted from the transmission apparatus. In other words, as shown in the lower row of FIG. 7, the reception apparatus is in a BUSY state while receiving the data from the legacy apparatus and is unable to receive the RTA data from the transmission apparatus.

In the example of FIG. 7, the operation after the third R-TWT SP period is the same as that after the second R-TWT SP period, and the operation in the fourth R-TWT SP period is the same as that in the first R-TWT SP period, so the description thereof will be omitted.

### Description of Example of Communication Operation for RTA Data Performed Using R-TWT Technology Without Considering Legacy Apparatus

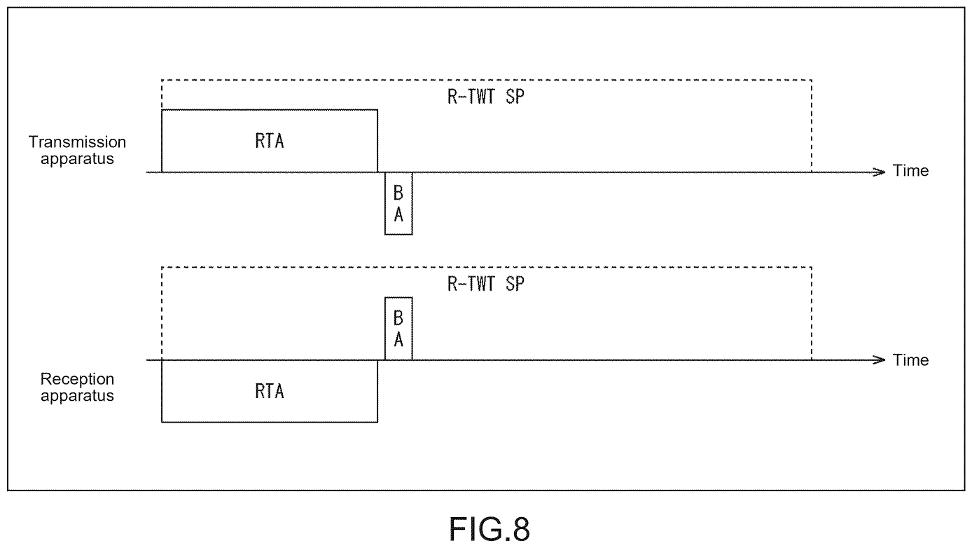

FIG. 8 is a timing chart for describing an example of a communication operation for RTA data performed within the R-TWT SP period in the communication operation of FIG. 7.

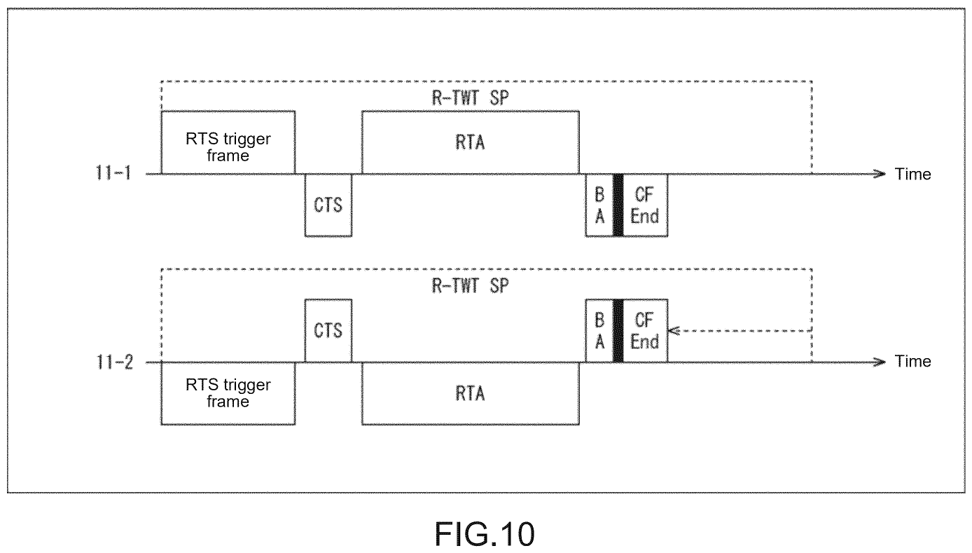

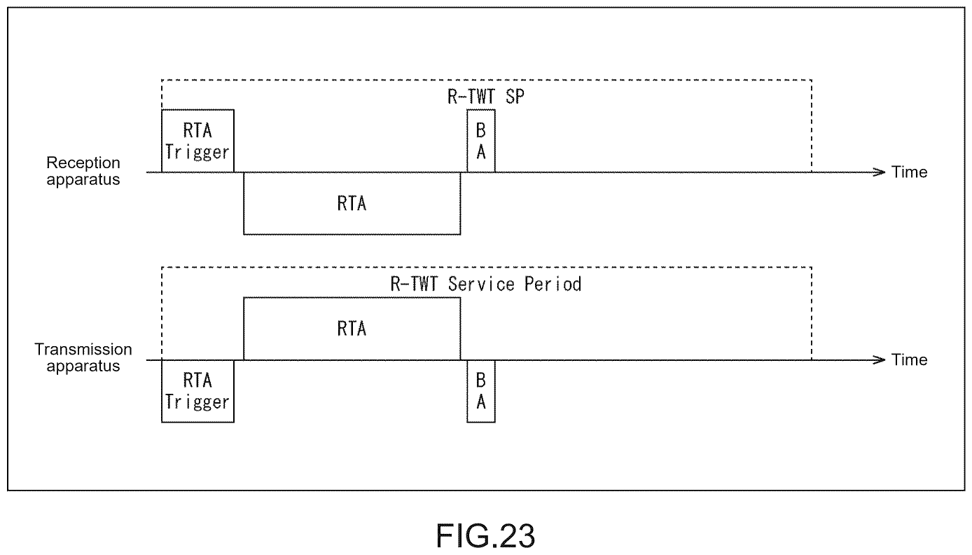

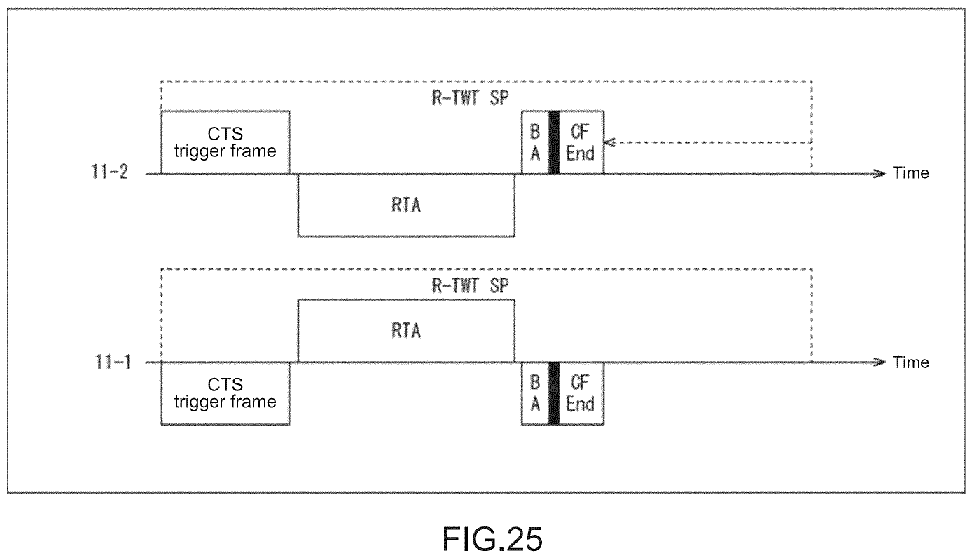

The upper row of FIG. 8 indicates an operation of the transmission apparatus, and the lower row indicates an operation of the reception apparatus. Note that in FIG. 8 the transmitting operation is indicated to be convex upward, and the receiving operation is indicated to be convex downward. The dotted-line rectangle indicates the R-TWT SP period. The horizontal axis of FIG. 8 represents time. This also applies to FIG. 10, FIG. 23, and FIG. 25, which will be described later.

As shown in the upper row of FIG. 8, when the R-TWT SP period starts, the transmission apparatus transmits RTA data. As shown in the lower row of FIG. 8, the reception apparatus receives that RTA data, and after the reception, returns a BA frame to the transmission apparatus. As shown in the upper row of FIG. 8, the transmission apparatus receives that BA frame from the reception apparatus.

Note that, in FIG. 8, for example, the transmission apparatus can operate as an access point, and the reception apparatus can operate as a station. In this case, the RTA data is downlink data.

As shown in FIGS. 7 and 8, when the communication of RTA data is performed using the R-TWT technology without considering the legacy apparatuses, that communication is subject to interference from the communication of the legacy apparatuses. This impairs the reliability of the communication of RTA data. In this regard, the wireless communication system 10 performs communication using the R-TWT technology by considering the legacy apparatuses 12.

### Description of Communication Operation Using R-TWT Technology by Wireless Communication System

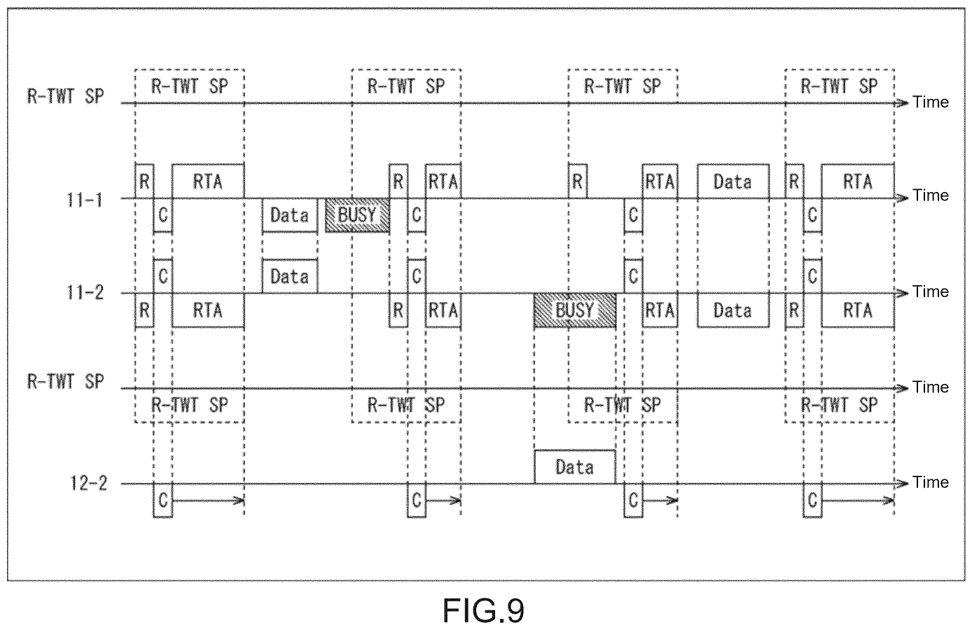

FIG. 9 is a timing chart showing an example of a communication operation using the R-TWT technology by the wireless communication system 10.

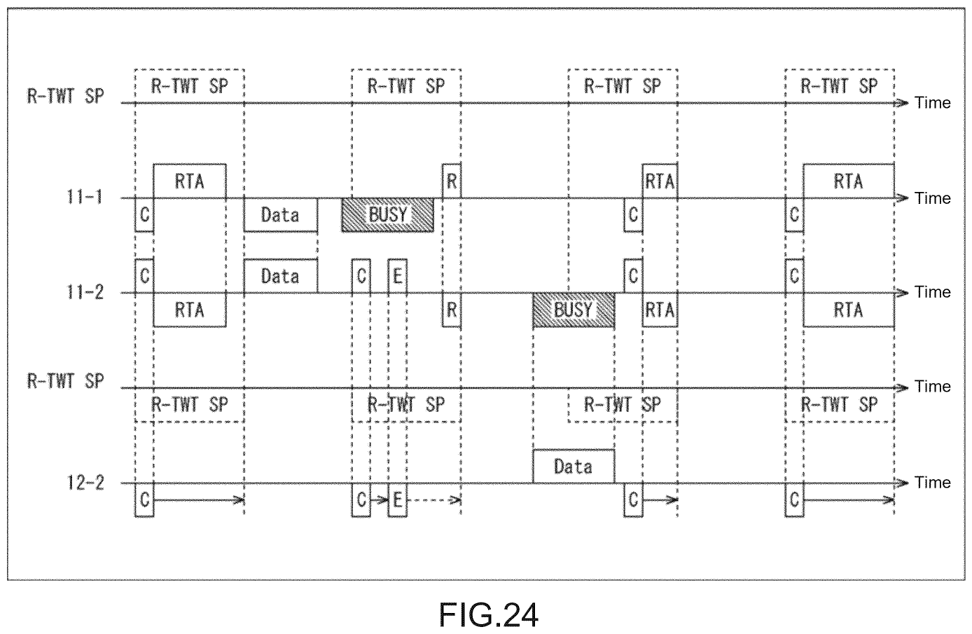

The first row from the top of FIG. 9 shows the R-TWT SP period set by the non-legacy apparatus 11-1. The second row shows the operation of the non-legacy apparatus 11-1. The third row shows the operation of the non-legacy apparatus 11-2. The fourth row shows the R-TWT SP period set by the non-legacy apparatus 11-2. The bottom fifth row shows the operation of the legacy apparatus 12-2. In the second, third, and fifth rows of FIG. 9, the transmitting operation is shown to be convex upward, and the receiving operation is shown to be convex downward. The horizontal axis in FIG. 9 represents time. This also applies to FIG. 24, which will be described later.

The non-legacy apparatuses 11-1 and 11-2 perform the real-time parameter exchange processing shown in FIG. 4 and shares the real-time parameters before performing a communication operation using the R-TWT technology. Therefore, as shown in the first and fourth rows of FIG. 9, the R-TWT SP periods set on the basis of the real-time parameters shared by the non-legacy apparatuses 11-1 and 11-2 are the same.

When the first R-TWT SP period starts, that is, when the non-legacy apparatus 11-1 acquires the first transmission opportunity for the RTA data, as shown in the second row of FIG. 9, the non-legacy apparatus 11-1 transmits an RTS trigger frame indicated by R in FIG. 9.

As shown in the third row of FIG. 9, the non-legacy apparatus 11-2 receives that RTS trigger frame and understands that it is prompted to receive the RTA data addressed to itself. The non-legacy apparatus 11-2 understands resource allocation information or the like necessary to receive the RTA data addressed to itself, from the allocation information included in the RTS trigger frame. Further, the non-legacy apparatus 11-2 returns a CTS frame that can be interpreted by both the non-legacy apparatus 11 and the legacy apparatus 12 in accordance with the RTS information included as legacy information in the RTS trigger frame. The CTS frame is set with Duration that indicates the time until the end of the first R-TWT SP period.

As shown in the second row of FIG. 9, the non-legacy apparatus 11-1 receives that CTS frame and transmits RTA data to the non-legacy apparatus 11-2, and as shown in the third row of FIG. 9, the non-legacy apparatus 11-2 receives that RTA data.

Meanwhile, as shown in the fifth row of FIG. 9, the legacy apparatus 12-2 also receives the CTS frame and sets the period from the current time to the time indicated by Duration set in the CTS frame, which is indicated by the arrow in FIG. 9, as NAV that is a transmission inhibition period. This prohibits the legacy apparatus 12-2 from performing transmission until the first R-TWT SP period ends, so that the non-legacy apparatus 11-2 can receive the RTA data reliably.

After the end of the first R-TWT SP period, in the example in FIG. 9, the non-legacy apparatus 11-2 transmits data other than the RTA data as shown in the third row of FIG. 9, and the non-legacy apparatus 11-1 receives that data as shown in the second row of FIG. 9.

Also at the start of the second R-TWT SP period, the non-legacy apparatus 11-1 wants to transmit an RTS trigger frame in the same way as at the start of the first R-TWT SP period, but the transmission path may be in a BUSY state as shown in the second row of FIG. 9. In this case, the non-legacy apparatus 11-1 does not transmit the RTS trigger frame until the BUSY state is resolved. If the BUSY state is resolved within the second R-TWT SP period, the non-legacy apparatus 11-1 transmits the RTS trigger frame to the non-legacy apparatus 11-2. The operation after this is the same as that in the first R-TWT SP period, and thus the description thereof will be omitted.

As described above, the non-legacy apparatus 11-1 transmits the RTS trigger frame after the BUSY state is resolved, and then transmits the RTA data, so that the delay in transmitting RTA data can be suppressed. Note that the non-legacy apparatus 11-2 may transmit the RTS trigger frame immediately after the BUSY state is resolved, or it may transmit the RTS trigger frame after a predetermined time elapses after the BUSY state is resolved.

If the transmission path of the non-legacy apparatus 11-2 is in a BUSY state at the start of the third R-TWT SP period as shown in the third row of FIG. 9, it is difficult for the non-legacy apparatus 11-2 to detect the RTS trigger frame. Therefore, at the start of the third R-TWT SP period, even if the non-legacy apparatus 11-1 transmits the RTS trigger frame as shown in the second row of FIG. 9, no CTS frame is returned from the non-legacy apparatus 11-2. Therefore, if the transmission path of the non-legacy apparatus 11-2 is in a BUSY state, the legacy apparatus 12-2 can transmit any data as shown in the fifth row of FIG. 9.

If the BUSY state is resolved within the R-TWT SP period, the non-legacy apparatus 11-2 transmits a CTS frame as shown in the third row of FIG. 9. The operation after this is the same as in the first R-TWT SP period, and thus the description thereof will be omitted.

As described above, the non-legacy apparatus 11-2 can notify the non-legacy apparatus 11-1 of the state where it can receive RTA data by transmitting a CTS frame after the BUSY state is resolved. Note that the non-legacy apparatus 11-2 may transmit the CTS frame immediately after the BUSY state is resolved, or it may transmit the CTS frame after a predetermined time elapses after the BUSY state is resolved.

After the end of the third R-TWT SP period, in the example in FIG. 9, the non-legacy apparatus 11-1 transmits data other than the RTA data as shown in the second row of FIG. 9, and the non-legacy apparatus 11-2 receives that data as shown in the third row of FIG. 9. The operation in the fourth R-TWT SP period is the same as that in the first R-TWT SP period, and thus the description thereof will be omitted.

Note that Duration set for the CTS frame may indicate the time until the end of the reception of RTA data, rather than the time until the end of the R-TWT SP period. In this case, the pressure on communication other than the RTA data communication on the transmission path can be suppressed. In the example in FIG. 9, if the start of the transmission of the RTA data is delayed due to the BUSY state of the transmission path, only the RTA data that can be transmitted by the end of the R TWT SP period among the RTA data planned to be transmitted is transmitted, but all the RTA data planned to be transmitted may be transmitted.

As described above, the non-legacy apparatus 11-1 transmits the RTS trigger frame that includes RTS information and allocation information. Therefore, the non-legacy apparatus 11-1 can not only understand the allocation information, but also return a CTS frame in response to the RTS information. This allows the legacy apparatus 12-2 to set the NAV in accordance with the CTS frame, thereby preventing interference with the RTA data communication due to transmitting data during the R-TWT SP period. As a result, the transmission of RTA data can be prioritized in a stable manner. Therefore, the reliability of low latency transmission of RTA data is improved.

### Description of Communication Operation for RTA Data in Wireless Communication System

FIG. 10 is a timing chart for describing a communication operation for RTA data performed within the R-TWT SP period in the communication operation of FIG. 9.

The upper row of FIG. 10 indicates an operation of the non-legacy apparatus 11-1, and the lower row indicates an operation of the non-legacy apparatus 11-2.

As shown in the upper row of FIG. 10, when the R-TWT SP period starts, the non-legacy apparatus 11-1 transmits the RTS trigger frame. As shown in the lower row of FIG. 10, the non-legacy apparatus 11-2 receives that RTS trigger frame and returns a CTS frame if it can receive RTA data.

As shown in the upper row of FIG. 10, the non-legacy apparatus 11-1 receives that CTS frame and then transmits the RTA data. As shown in the lower row of FIG. 10, the non-legacy apparatus 11-2 receives that RTA data, and after the reception of the RTA data, returns a BA frame to the non-legacy apparatus 11-1. As shown in the upper row of FIG. 10, the non-legacy apparatus 11-1 receives that BA frame.

Note that if the remaining period before the end of the R-TWT SP period is a predetermined period or more, the non-legacy apparatus 11-2 can transmit a CF-END frame in conjunction with the BA frame. The CF-END frame is a MAC frame that can be interpreted by both the non-legacy apparatuses 11 and the legacy apparatuses 12. By transmitting the CF-END frame, the non-legacy apparatus 11-2 can explicitly notify that the remaining period in the R-TWT SP period has been cancelled and any data communication is now allowed between any wireless communication apparatuses. Therefore, the transmission path for the remaining period in the R-TWT SP period can be used for communication of data other than the RTA data, thereby improving the utilization efficiency of the transmission path.

The non-legacy apparatus 11-2 may transmit the CF-END frame in conjunction with the BA frame or may transmit only the BA frame, regardless of whether the remaining period before the end of the R-TWT SP period is a predetermined period or more. The non-legacy apparatus 11-2 may also transmit only the CF-END frame.

If the non-legacy apparatus 11-1 operates as an access point and the non-legacy apparatus 11-2 operates as a station in FIG. 10, the RTA data is downlink data.

### Description of RTA Data Communication Processing

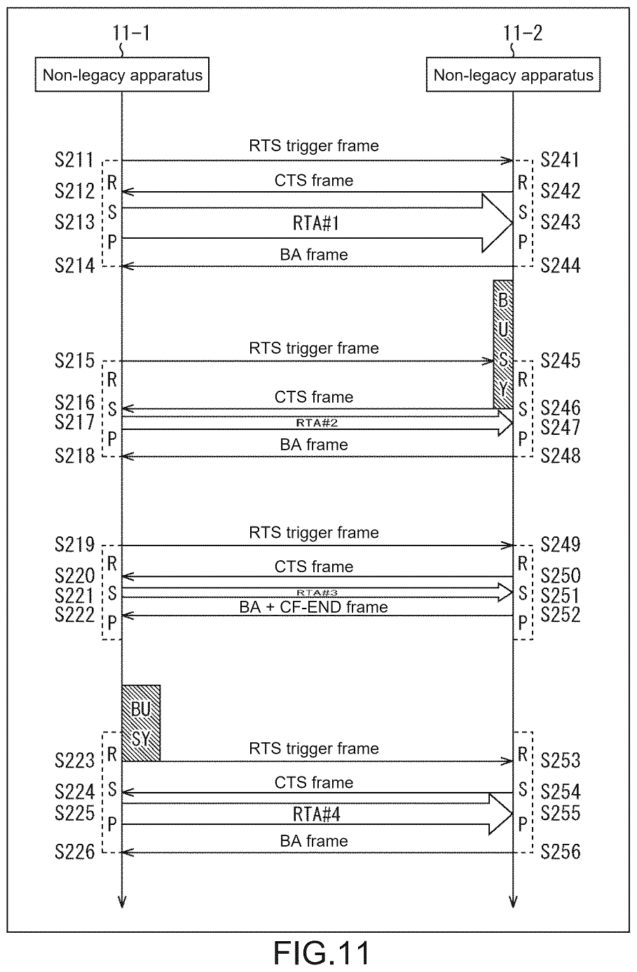

FIG. 11 is a flowchart for describing RTA data communication processing that is performed between the non-legacy apparatuses 11-1 and 11-2 to transmit and receive RTA data by using the R-TWT technology.

In the R-TWT SP period indicated by the dotted-line rectangle in which RSP is described in FIG. 11, when the first R-TWT SP period starts, the non-legacy apparatus 11-1 performs processing of Step S211 in FIG. 11. Specifically, in Step S211, the transmission controller 57 of the non-legacy apparatus 11-1 transmits the encoded data of the RTS trigger frame constructed by the control frame construction section 56 to the non-legacy apparatus 11-2 via the antenna section 59.

In Step S241, the reception controller 60 of the non-legacy apparatus 11-2 receives the encoded data of the RTS trigger frame transmitted in Step S211 via the antenna section 59.

In Step S242, the transmission controller 57 returns the encoded data of the CTS frame constructed by the control frame construction section 56 in accordance with the RTS information included in that RTS trigger frame to the non-legacy apparatus 11-1 via the antenna section 59.

In Step S212, the reception controller 60 receives the encoded data of the CTS frame transmitted in Step S242 via the antenna section 59. In Step S213, the transmission controller 57 transmits the encoded data of RTA #1 constructed by the data frame construction section 54 in accordance with the CTS frame to the non-legacy apparatus 11-2 via the antenna section 59. RTA #1 is a data frame of the RTA data for the first R-TWT SP period.

In Step S243, the reception controller 60 receives the encoded data of RTA #1 transmitted in Step S213 via the antenna section 59. If the remaining period from the completion of reception of the encoded data of RTA #1 until the end of the first R-TWT SP period is not a predetermined period or more, the transmission controller 57 performs processing of Step S244. Specifically, in Step S244, the transmission controller 57 transmits the BA frame constructed by the control frame construction section 56 in response to the completion of reception of the encoded data of RTA #1 to the non-legacy apparatus 11-1 via the antenna section 59.

In Step S214, the reception controller 60 receives the BA frame transmitted in Step S244 via the antenna section 59.

When the second R-TWT SP period starts, in Step S215, the non-legacy apparatus 11-1 transmits the RTS trigger frame to the non-legacy apparatus 11-2, similarly to the processing of Step S211.

In Step S245, the non-legacy apparatus 11-2 receives the encoded data of the RTS trigger frame transmitted in Step S215, similarly to the processing of Step S241. However, if the transmission path of the non-legacy apparatus 11-2 is in a BUSY state at that time, the encoded data of that RTS trigger frame cannot be decoded accurately. Therefore, the non-legacy apparatus 11-2 waits until the BUSY state of the transmission path is resolved.

The non-legacy apparatus 11-1 does not transmit RTA data because no CTS frame is returned from the non-legacy apparatus 11-2. At that time, the non-legacy apparatus 11-1 may transmit the encoded data of the MAC frame addressed to another apparatus other than the non-legacy apparatus 11-2, but in the example of FIG. 11, the non-legacy apparatus 11-1 gives priority to transmission of RTA data and waits until it detects the return of a CTS frame.

When the BUSY state of the transmission path of the non-legacy apparatus 11-2 is resolved, the processing of Step S246 is performed.

The processing of Steps S246 to S248 and Steps S216 to S218 are similar to the processing of Steps S242 to S244 and S212 to S214 except that RTA #1 is replaced with RTA #2, and thus the description thereof will be omitted. RTA #2 is a data frame of RTA data for the second R-TWT SP period. Note that in Step S217 the non-legacy apparatus 11-1 may transmit only the data frames of RTA data in RTA #2, which correspond to the amount of data that can be transmitted in the time until the end of the second R-TWT SP period.

When the third R-TWT SP period starts, the non-legacy apparatus 11-1 performs the processing of Step S219. The processing of Steps S219 to S221 and S249 to S251 are similar to the processing of Steps S211 to S213 and S241 to S243 except that RTA #1 is replaced with RTA #3, and thus the description thereof will be omitted. RTA #3 is a data frame of RTA data for the third R-TWT SP period.

In Step S251, if the remaining period from the completion of reception of the encoded data of RTA #3 until the end of the third R-TWT SP period is a predetermined period or more, the transmission controller 57 performs processing of Step S252. Specifically, in Step S252, the transmission controller 57 concatenates the BA frame and CF-END frame constructed by the control frame construction section 56 to be encoded in response to the completion of reception of the encoded data of RTA #3 and transmits them via the antenna section 59.

In Step S222, the reception controller 60 receives the encoded data obtained by concatenating and encoding the BA frame and the CF-END frame, which has been transmitted in Step S252, via the antenna section 59.

Next, when the fourth R-TWT SP period starts, if the transmission path of the non-legacy apparatus 11-1 is in a BUSY state, the non-legacy apparatus 11-1 waits until the BUSY state of the transmission path is resolved. When the BUSY state of the transmission path of the non-legacy apparatus 11-1 is resolved, the processing of Step S223 is performed. The processing of Steps S223 to S226 and S253 to S256 are similar to the processing of Steps S211 to S214 and S241 to S244 except that RTA #1 is replaced with RTA #4, and thus the description thereof will be omitted. RTA #4 is a data frame of RTA data for the fourth R-TWT SP period.

Note that in Step S225 the non-legacy apparatus 11-1 may transmit only the data frames of RTA data in RTA #4, which correspond to the amount of data that can be transmitted in the time until the end of the fourth R-TWT SP period.

### Example of Data Structure of Trigger Frame

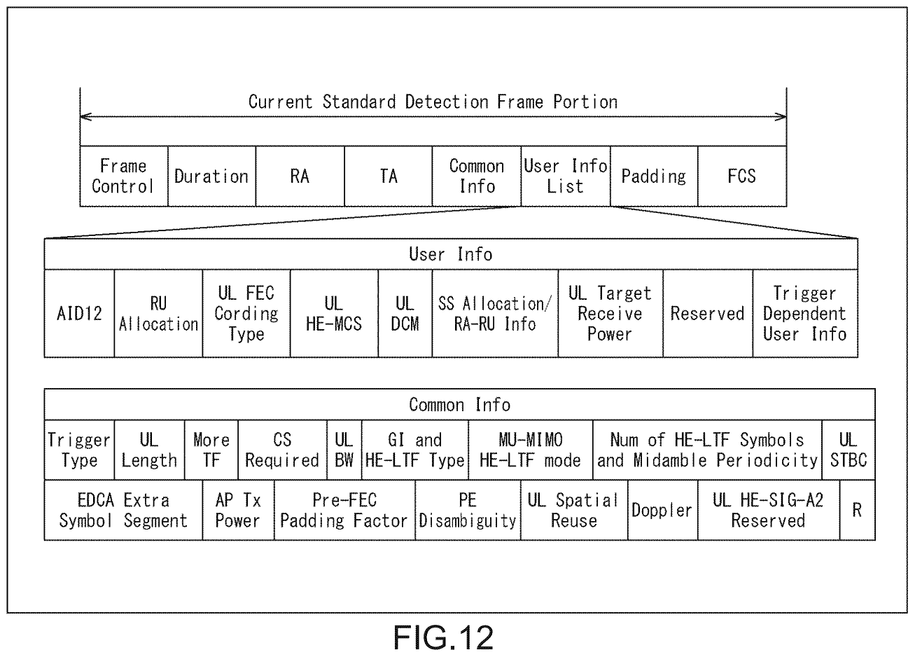

FIG. 12 is a diagram showing an example of a data structure of a trigger frame specified in IEEE802.11.

As shown in the upper row of FIG. 12, the data of the trigger frame includes Frame Control indicating the frame format of this trigger frame, Duration indicating a duration, and RA that is address information of the destination of this trigger frame. The data of the trigger frame also includes TA that is address information of the transmission source of this trigger frame, Common Info including information common to all users, User Info List including individual information of each user, and Padding that is added as necessary. The data of the trigger frame further includes Frame Check Sequence (FCS) for error detection.

User Info List includes User Info, which is individual information for each user. As shown in the middle row of FIG. 3, User Info includes AID12 that is information for identifying a target wireless communication apparatus or application, RU Allocation that specifies the resource unit to be used for wireless communication, and UL FEC Coding Type that indicates the coding format of uplink communication. Use Info also includes UL HE-MCS and UL-DMC that indicate the coding scheme of uplink communication, SS Allocation/RA-RU Info that indicates the spatial multiplex allocation and random access resource unit, and UL Target Receive Power that indicates received power of an uplink target. Use Info also includes Reserved that is a reserved area for expansion. Use Info also includes Trigger Depend User Info that is added as trigger-dependent user information as necessary.

As shown in the lower row of FIG. 3, Common Info includes Trigger Type, UL Length, More TF, CS Required, ULBW, GI and HE-LTF Type, MU-MIMO HE-LTF mode, Num of HE-LTF Symbols and Midamble Periodicity, UL STBC, EDCA Extra Symbol Segment, and AP Tx Power. Common Info also includes Pre-FEC Padding Factor, PE Disambiguity, UL Spatial Reuse, Doppler, UL HE-SIG-A2 Reserved, and R as Reserved.

In the information included as data in the trigger frame configured as described above, information other than the RTS information except for FCS is the allocation information. Specifically, the allocation information includes Common Info, User Info List, Padding, and FCS.

This allocation information allows the non-legacy apparatus 11-2 to understand the resource allocation information or the like necessary to receive the RTA data addressed to itself. For example, the non-legacy apparatus 11-2 can identify the non-legacy apparatus 11-1 that transmits the RTA data. The non-legacy apparatus 11-1 can recognize the allocation of resources in the time direction, such as the amount of RTA data to be received and the length of the R-TWT SP period, by Trigger Dependent User Info, UL length, etc. The non-legacy apparatus 11-1 can recognize the allocation of resources in the frequency direction, such as the receiving channel of RTA data, by ULBW etc.

### First Configuration Example of RTS Trigger Frame

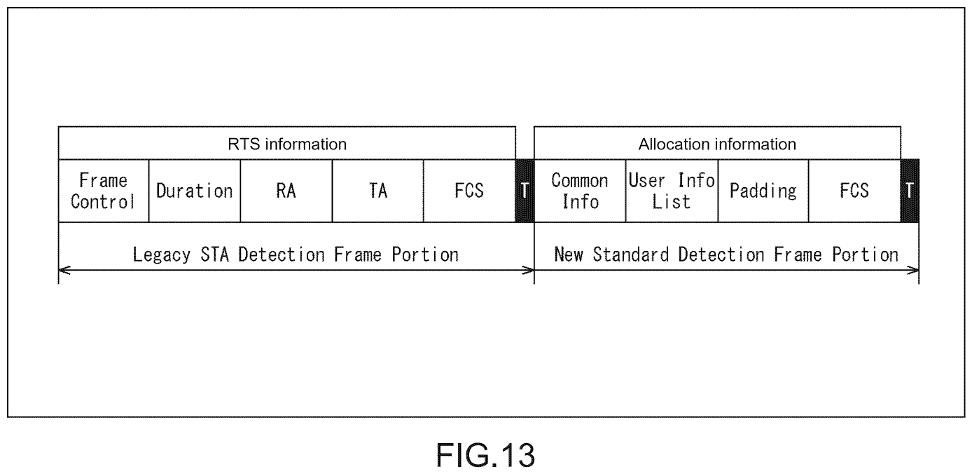

FIG. 13 is a diagram showing a first configuration example of the RTS trigger frame.

In the RTS trigger frame shown in FIG. 13, RTS information and allocation information are disposed as data in the same control frame, so that the RTS information and the allocation information are disposed to be associated with each other. Specifically, RTS information, Tail, which is a bit string indicating a signal delimitation position, allocation information, and Tail are disposed in the data in the RTS trigger frame, in order from the head. The RTS information includes Frame Control, Duration, RA, TA, and FCS.

The RTS trigger frame of FIG. 13 includes RTS information that can be interpreted by the legacy apparatus 12 as data, and thus the legacy apparatus 12 can acquire the RTS information. Note that Tail is disposed after the RTS information, and thus the legacy apparatus 12 can perform termination processing.

The RTS trigger frame of FIG. 13 includes RTS information and allocation information that are included in the trigger frame that can be interpreted as data by the non-legacy apparatus 11. Therefore, the non-legacy apparatus 11 can acquire the same information as in the case of interpreting the trigger frame by acquiring the RTS information followed by the allocation information. Note that Tail is disposed after the allocation information, and thus the non-legacy apparatus 11 can perform termination processing.

### Example of Data Structure of CF-END Frame

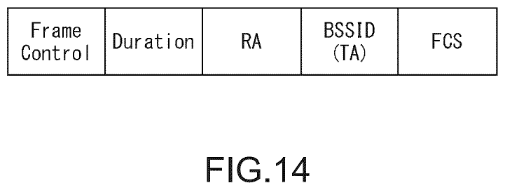

FIG. 14 is a diagram showing an example of a data structure of a CF-END frame.

The data of the CF-END frame of FIG. 14 includes Frame Control indicating the frame format of this CF-END frame, Duration indicating a duration, and RA that is address information of the destination of this CF-END frame. The data of the CF-END frame also includes BSSID as an identifier of Basic Service Set (BSS) to which the transmission source of the CF-END frame belongs, or TA as address information, and FCS for error detection.

Note that when the CF-END frame is concatenated with the BA frame and then transmitted, Tail may be added between the BA frame and the CF-END frame. This allows the non-legacy apparatus 11 and the legacy apparatus 12 to perform termination processing.

### Description of RTS Trigger Frame Transmission Processing

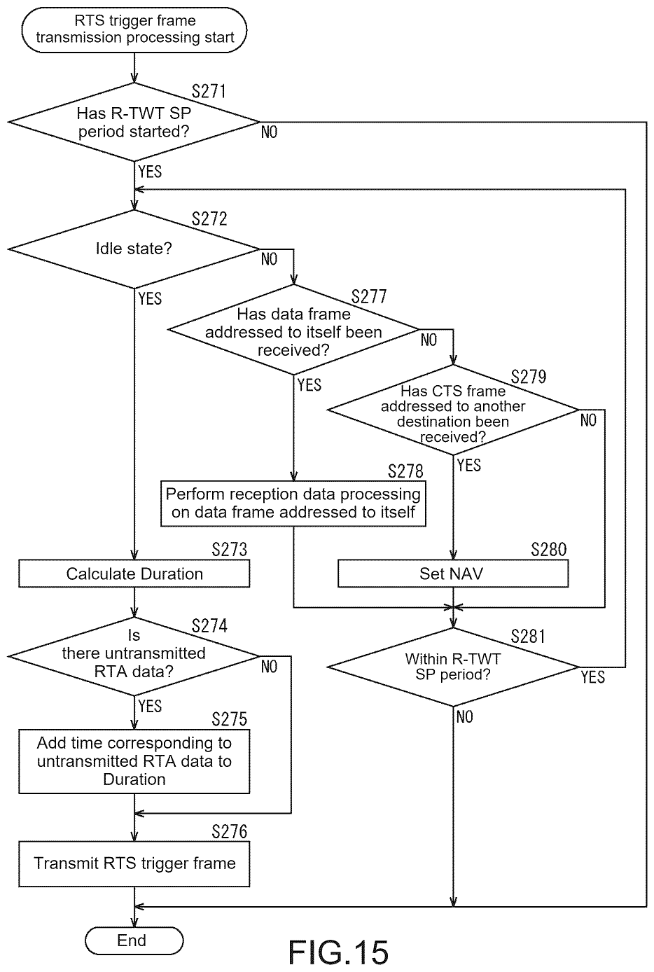

FIG. 15 is a flowchart for describing RTS trigger frame transmission processing in which the non-legacy apparatus 11-1 transmits the RTS trigger frame.

In Step S271 of FIG. 15, the transmission opportunity management section 55 of the non-legacy apparatus 11-1 determines whether or not the R-TWT SP period has started. If it is determined in Step S271 that the R-TWT SP period has started, the processing proceeds to Step S272.

In Step S272, the access controller 58 determines whether or not the state of the transmission path (media) notified by the reception controller 60 is an idle state. If it is determined in Step S272 that the state is an idle state, the processing proceeds to Step S273. In Step S273, the RTA management section 53 calculates the time corresponding to the RTA data to be transmitted in the current R-TWT SP period as Duration.

In Step S274, the RTA management section 53 determines whether or not there is untransmitted RTA data, which should have been transmitted in the previous R-TWT SP period, in the transmission buffer 52. If it is determined in Step S274 that there is untransmitted RTA data, in Step S275, the RTA management section 53 adds the time corresponding to that untransmitted RTA data to the Duration calculated in Step S273. The control frame construction section 56 then constructs an RTS trigger frame including that Duration, supplies it to the transmission controller 57, and proceeds to Step S276.

On the other hand, if it is determined in Step S274 that there is no untransmitted RTA data, the control frame construction section 56 constructs an RTS trigger frame including the Duration calculated in Step S273, supplies it to the transmission controller 57, and proceeds to Step S276.

In Step S276, the transmission controller 57 transmits the encoded data of the RTS trigger frame including the Duration calculated in Step S273 or S275 to the non-legacy apparatus 11-2 via the antenna section 59. Then, the RTS trigger frame transmission processing ends.

On the other hand, if it is determined in Step S271 that the R-TWT SP period has not started, the RTS trigger frame transmission processing ends.

If it is determined in Step S272 that the state is not an idle state, in Step S277, the reception controller 60 determines whether or not the encoded data of the data frame addressed to itself has been received. If it is determined in Step S277 that the encoded data of the data frame addressed to itself has been received, in Step S278, the reception controller 60 performs reception data processing, such as decoding by the reception controller 60, extraction by the data frame extraction section 62, and storage in the reception buffer 63, on that encoded data. The processing then proceeds to Step S281.

If it is determined in Step S277 that the encoded data of the data frame addressed to itself has not been received, in Step S279, the reception controller 60 determines whether or not the encoded data of a CTS frame addressed to another destination has been received. If it is determined in Step S279 that the encoded data of a CTS frame addressed to another destination has been received, the reception controller 60 supplies that CTS frame to the control frame extraction section 61 and proceeds to Step S280.

In Step S280, the access controller 58 acquires the Duration extracted from the CTS frame addressed to another destination by the control frame extraction section 61, and sets NAV for the period from the current time to the time indicated by the Duration. The processing then proceeds to Step S281.

If it is determined in Step S279 that the encoded data of a CTS frame addressed to another destination has not been received, the processing proceeds to Step S281.

In Step S281, it is determined whether or not the current time is within the R-TWT SP period. If it is determined in Step S281 that the current time is within the R-TWT SP period, the processing returns to Step S272, and the subsequent processing is performed.

On the other hand, if it is determined in Step S281 that the current time is not within the R-TWT SP period, i.e., the R-TWT SP period has ended, the RTS trigger frame transmission processing ends.

Note that the Duration of the RTS trigger frame is assumed to be larger than 0 in the example of FIG. 15. If the Duration is 0, that is, if there is no RTA data to be transmitted in the current R-TWT SP period, the processing of Step S276 is not performed.

### Description of RTA Data Transmission Processing

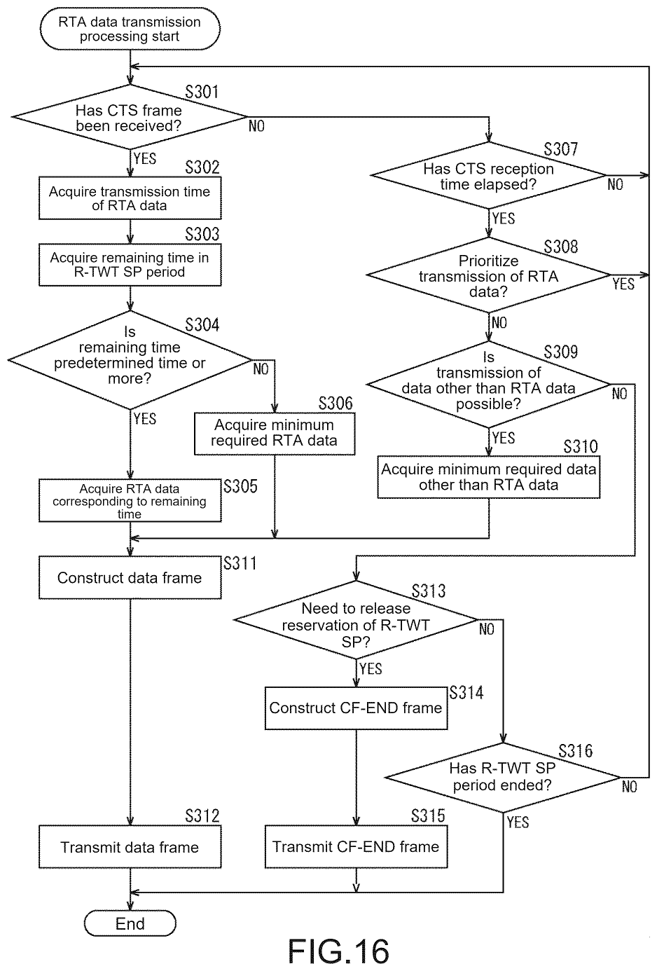

FIG. 16 is a flowchart for describing RTA data transmission processing in which the non-legacy apparatus 11-1 transmits RTA data.

In Step S301 of FIG. 16, the reception controller 60 of the non-legacy apparatus 11-1 determines whether or not the encoded data of the CTS frame transmitted from the non-legacy apparatus 11-2 has been received. If it is determined in Step S301 that the encoded data of the CTS frame has been received, the reception controller 60 supplies that CTS frame to the control frame extraction section 61. Thus, the information included in the CTS frame is supplied to the RTA management section 53 via the transmission opportunity management section 55 as necessary. In Step S302, the transmission opportunity management section 55 then acquires the transmission time of the RTA data to be transmitted in the current R-TWT SP period, which has been calculated by the RTA management section 53.

In Step S303, the transmission opportunity management section 55 acquires the remaining time in the current R-TWT SP period. In Step S304, the transmission opportunity management section 55 determines whether or not the remaining time acquired in Step S303 is a predetermined time or more.

If it is determined in Step S304 that the remaining time is a predetermined time or more, in Step S305, the data frame construction section 54 acquires the RTA data corresponding to the remaining time among the RTA data to be transmitted in the current R-TWT SP period, from the transmission buffer 52, and proceeds to Step S311.

If it is determined in Step S304 that the remaining time is not a predetermined time or more, in Step S306, the data frame construction section 54 acquires the minimum required RTA data among the RTA data to be transmitted in the current R-TWT SP period, from the transmission buffer 52. The processing then proceeds to Step S311.

On the other hand, if it is determined in Step S301 that the encoded data of the CTS frame has not been received, the processing proceeds to Step S307. In Step S307, the non-legacy apparatus 11-1 determines whether or not a CTS reception time has elapsed, the CTS reception time being assumed to be the time from the transmission of the RTS trigger frame by the non-legacy apparatus 11-1 to the reception of the CTS frame.

If it is determined in Step S307 that the CTS reception time has elapsed, in Step S308, the access controller 58 determines whether to prioritize transmission of RTA data. If it is determined in Step S308 that transmission of RTA data is not prioritized, i.e., the transmission path is to be used effectively, the processing proceeds to Step S309.

In Step S309, the access controller 58 determines whether or not data other than RTA data can be transmitted. If it is determined in Step S309 that data other than RTA data can be transmitted, in Step S310, the data frame construction section 54 acquires the minimum required data other than RTA data from the transmission buffer 52 and proceeds to Step S311.

In Step S311, the data frame construction section 54 constructs a data frame of the RTA data acquired in Step S305 or S306 or a data frame of data other than the RTA data acquired in Step S310, and supplies it to the transmission controller 57. In Step S312, the transmission controller 57 transmits the encoded data of the data frame constructed in Step S311 via the antenna section 59 and terminates the RTA data transmission processing.

If it is determined in Step S309 that data other than RTA data cannot be transmitted, in Step S313, the access controller 58 determines whether to need to release the reservation of the R-TWT SP. If it is determined in Step S313 that the release of the reservation of the R-TWT SP is necessary, in Step S314, the control frame construction section 56 constructs a CF-END frame and supplies it to the transmission controller 57. In Step S315, the transmission controller 57 transmits the encoded data of the CF-END frame constructed in Step S314 via the antenna section 59 and terminates the RTA data transmission processing.

On the other hand, if it is determined in Step S313 that the release of the reservation of the R-TWT SP is not necessary, it is determined in Step S316 whether or not the R-TWT SP period has ended. If it is determined in Step S316 that the R-TWT SP period has not ended, the processing returns to Step S301 and the subsequent processing is performed. If it is determined in Step S316 that the R-TWT SP period has ended, the RTA data transmission processing ends.

If it is determined in Step S307 that the CTS reception time has not elapsed or if it is determined in Step S308 that priority is given to transmission of RTA data, the processing returns to Step S301 and the subsequent processing is repeated.

### Description of RTA Data Reception Processing

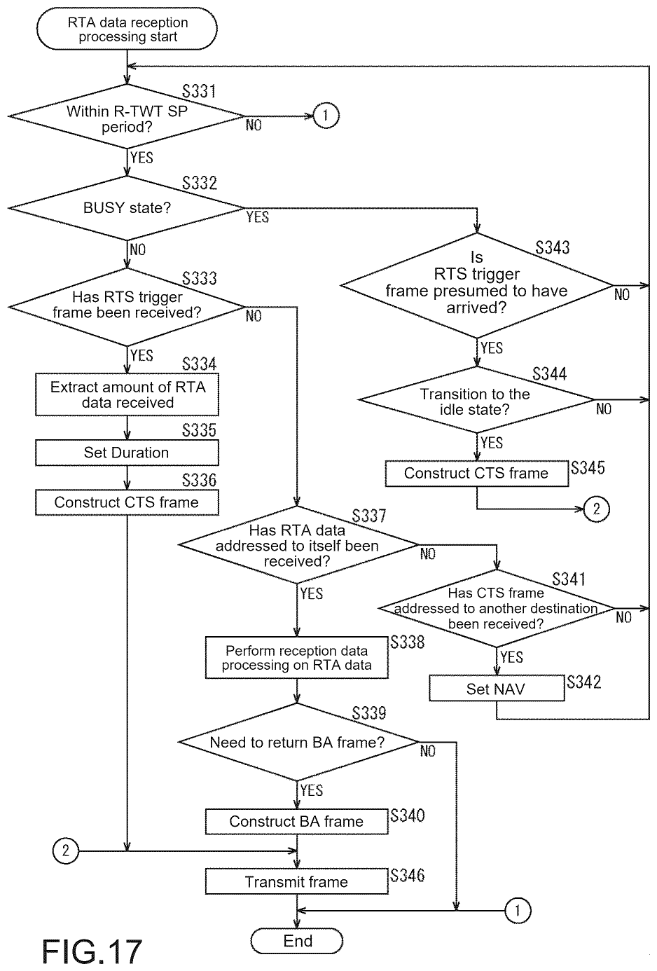

FIG. 17 is a flowchart for describing RTA data reception processing in which the non-legacy apparatus 11-2 receives RTA data.

In Step S331 of FIG. 17, the transmission opportunity management section 55 determines whether or not the current time is within the R-TWT SP period. If it is determined in Step S401 that the current time is within the R-TWT SP period, in Step S332, the access controller 58 detects whether or not the transmission path is in a BUSY state.

If it is determined in Step S332 that the transmission path is not in a BUSY state, i.e., the transmission path is in use or in an idle state, the processing proceeds to Step S333. In Step S333, the reception controller 60 determines whether or not the encoded data of the RTS trigger frame has been received from the non-legacy apparatus 11-2. If it is determined in Step S333 that the encoded data of the RTS trigger frame has been received, the reception controller 60 performs decoding or the like on the encoded data of the RTS trigger frame to supply the RTS trigger frame to the control frame extraction section 61. The processing then proceeds to Step S334.

In Step S334, the control frame extraction section 61 extracts the amount of RTA data received, which is the data amount of RTA data to be received, from the RTS trigger frame. In Step S335, the transmission opportunity management section 55 sets the time to be included as Duration in a CTS frame and supplies it to the control frame construction section 56.

In Step S336, the control frame construction section 56 constructs a CTS frame including the Duration set in Step S335 and supplies it to the transmission controller 57. The processing then proceeds to Step S346.

On the other hand, if it is determined in Step S333 that the RTS trigger frame has not been received, the processing proceeds to Step S337. In Step S337, the reception controller 60 determines whether or not the encoded data of the data frame of the RTA data addressed to itself has been received. If it is determined in Step S337 that the encoded data of the data frame of the RTA data addressed to itself has been received, in Step S338, the non-legacy apparatus 11-2 performs the reception data processing on the encoded data.

In Step S339, the transmission opportunity management section 55 determines whether to need to return a BA frame. If it is determined in Step S339 that a BA frame needs to be returned, in Step S340, the control frame construction section 56 constructs a BA frame and supplies it to the transmission controller 57. The processing then proceeds to Step S346.

On the other hand, if it is determined in Step S339 that the BA frame does not need to be returned, the RTA data reception processing ends.

If it is determined in Step S337 that the encoded data of the data frame of the RTA data addressed to itself has not been received, in Step S341, the reception controller 60 determines whether or not the encoded data of the CTS frame addressed to another destination has been received. If it is determined in Step S337 that the encoded data of the CTS frame addressed to another destination has been received, the reception controller 60 supplies the CTS frame to the control frame extraction section 61. In Step S342, the access controller 58 then sets NAV for the period from the current time to the time indicated by the Duration extracted from the CTS frame by the control frame extraction section 61. The processing then returns to Step S331, and the subsequent processing is repeated.

On the other hand, if it is determined in Step S341 that the encoded data of the CTS frame addressed to another destination has not been received, the processing returns to Step S331, and the subsequent processing is repeated.

If it is determined in Step S332 that the state is BUSY, in Step S343, the reception controller 60 determines whether or not the RTS trigger frame is presumed to have arrived. For example, if the reception controller 60 detects an increase in the signal level, from which it is presumed that the RTS trigger frame has been transmitted probably, at the timing when the RTS trigger frame would have arrived normally, the reception controller 60 determines that the RTS trigger frame is presumed to have arrived.

If it is determined in Step S343 that the RTS trigger frame is presumed to have arrived, in Step S344, the access controller 58 determines whether the state of the transmission path has transitioned to an idle state. If it is determined in Step S344 that the state has transitioned to an idle state, in Step S345, the control frame construction section 56 constructs a CTS frame and supplies it to the transmission controller 57. The processing then proceeds to Step S346.

In Step S346, the transmission controller 57 transmits the encoded data of the CTS frame constructed in Step S336 or S345 or of the BA frame constructed in Step S340 via the antenna section 59 to terminate the RTA data reception processing.

On the other hand, if it is determined in Step S343 that no RTS trigger frame is presumed to have arrived or if it is determined in Step S344 that the state has not transitioned to an idle state, the processing returns to Step S331 and the subsequent processing is repeated.

If it is determined in Step S331 that the current time is not within the R-TWT SP period, the RTA data reception processing ends.

Note that in the above description the RTS trigger frame is assumed to be a control frame in which RTS information and allocation information are associated with each other, but it can be any frame other than a control frame as long as it is a frame in which RTS information and allocation information are associated with each other. For example, the RTS trigger frame may be a frame such as an aggregation-MAC protocol data unit (A-MPDU), a PLCP protocol data unit (PPDU), an aggregation-PLCP protocol data unit (A-PPDU), a concatenated PPDU, or a frequency-multiplexed PPDU.

### Second Configuration Example of RTS Trigger Frame

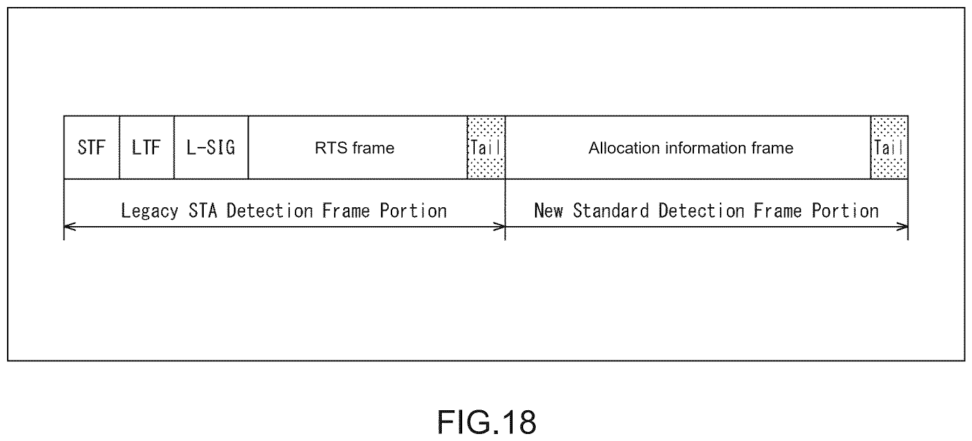

FIG. 18 is a diagram showing a configuration example of the RTS trigger frame as an A-MPDU.

The RTS trigger frame of FIG. 18 is an A-MPDU in which RTS information and allocation information are separately changed into MAC frames and aggregated, so that the RTS information and the allocation information are disposed to be associated with each other. Specifically, the RTS trigger frame of FIG. 18 includes one physical layer convergence protocol (PLCP) preamble, an RTS frame, Tail, an allocation information frame, and Tail in order from the head. The PLCP preamble includes short training field (STF), long training field (LTF), and L-SIG (Signal).

Since the RTS trigger frame of FIG. 18 includes an RTS frame that can be interpreted by the legacy apparatus 12, the legacy apparatus 12 can acquire RTS information. The RTS trigger frame also includes an allocation information frame corresponding to the trigger frame that can be interpreted by the non-legacy apparatus 11, and thus the non-legacy apparatus 11 can acquire both the RTS information and the allocation information.

### Third Configuration Example of RTS Trigger Frame

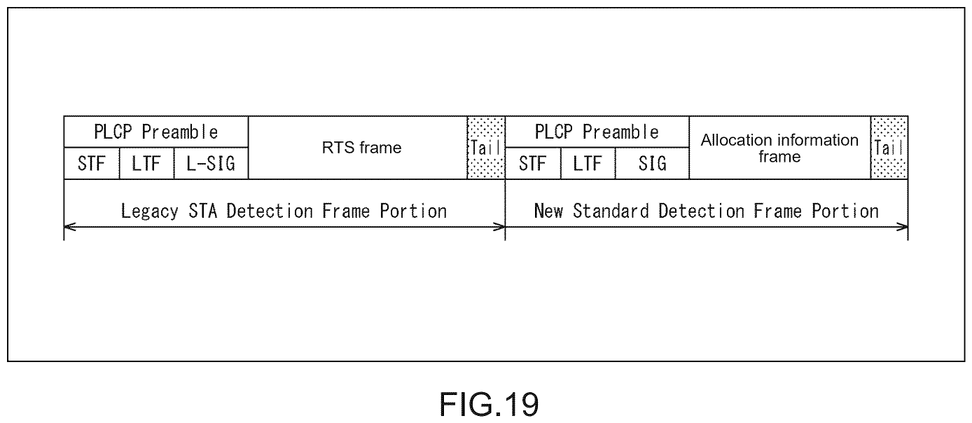

FIG. 19 is a diagram showing a configuration example of the RTS trigger frame as an A-PPDU.

The RTS trigger frame of FIG. 19 is an A-PPDU in which an RTS information frame and an allocation information frame are separately changed into PPDUs and aggregated, so that the RTS information and the allocation information are disposed to be associated with each other. Specifically, the RTS trigger frame of FIG. 19 includes an RTS information part (legacy portion) and an allocation information part (non-legacy portion) that are concatenated and disposed via Tail (interval). The RTS information part is a PPDU including a PLCP preamble (first preamble) and an RTS frame. The allocation information part is a PPDU including a PLCP preamble (second preamble) and an allocation information frame. The period of this Tail is shorter than the shortest inter frame space (IFS) disposed between MAC frames, for example, shorter than the short inter frame space (SIFS) period. Tail is disposed at the end of the allocation information frame.

The RTS trigger frame of FIG. 19 includes the RTS frame and the allocation information frame. Therefore, similarly to the case of FIG. 18, the legacy apparatus 12 can acquire the RTS information, and the non-legacy apparatus 11 can acquire both the RTS information and the allocation information.

### Fourth Configuration Example of RTS Trigger Frame

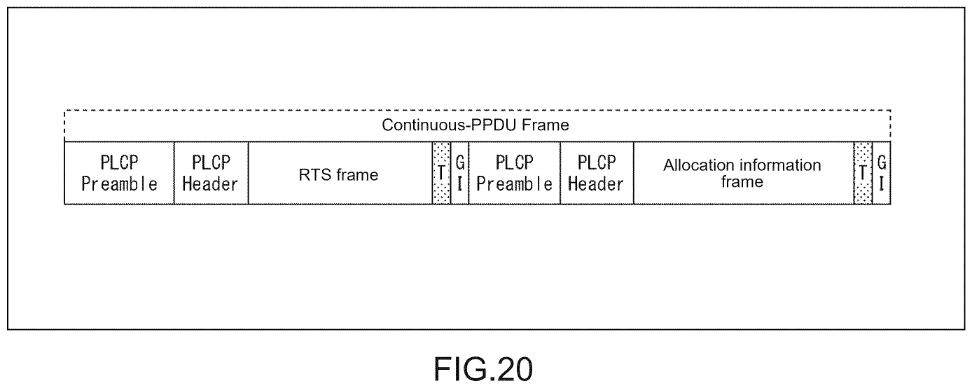

FIG. 20 is a diagram showing a configuration example of the RTS trigger frame as a concatenated PPDU.

The RTS trigger frame of FIG. 20 is a concatenated PPDU in which an RTS frame and an allocation information frame are separately changed into PPDUs and concatenated, so that RTS information and allocation information are disposed to be associated with each other. Specifically, the RTS trigger frame of FIG. 20 includes an RTS PPDU (legacy frame) and an allocation information PPDU (non-legacy frame) that are concatenated via GI (Guard Interval). The RTS PPDU includes a PLCP preamble (first preamble), a PLCP header (first header), an RTS frame, and Tail. The allocation information PPDU includes a PLCP preamble (second preamble), a PLCP header (second header), an allocation information frame, and Tail. The GI is disposed also at the end of the allocation information PPDU.

The RTS trigger frame of FIG. 20 includes the RTS frame and the allocation information frame. Therefore, as in the case of FIG. 18, the legacy apparatus 12 can acquire the RTS information, and the non-legacy apparatus 11 can acquire both the RTS information and the allocation information.

### Fifth Configuration Example of RTS Trigger Frame

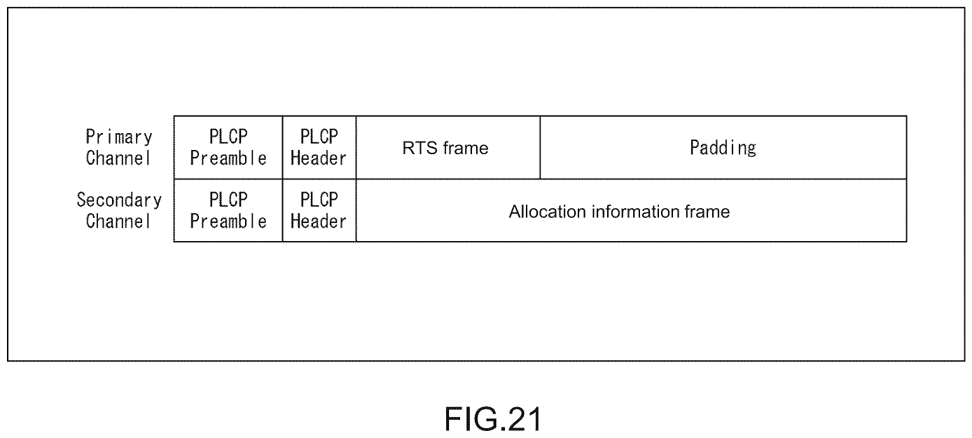

FIG. 21 is a diagram showing a configuration example of the RTS trigger frame as a frequency-multiplexed PPDU.

The RTS trigger frame of FIG. 21 is a PPDU in which an RTS frame and an allocation information frame are separately changed into PPDUs and multiplexed in the frequency direction, so that the RTS information and the allocation information are disposed to be associated with each other. Specifically, the RTS trigger frame of FIG. 21 is configured by multiplexing a PPDU of a main channel (primary channel) in which an RTS frame is disposed and a PPDU of a sub-channel (secondary channel) in which an allocation information frame is disposed. The PPDU of the primary channel includes a PLCP preamble, a PLCP header, and an RTS frame. The PPDU of the sub-channel includes a PLCP preamble, a PLCP header, and an allocation information frame.

Note that if the PPDU of the main channel and the PPDU of the sub-channel are different in information length, Padding is added to the shorter PPDU. In the example of FIG. 21, the information length of the PPDU of the main channel is shorter than that of the PPDU of the sub-channel, and Padding is added to the PPDU of the main channel.

The RTS trigger frame of FIG. 21 includes the RTS frame and the allocation information frame. Therefore, as in the case of FIG. 18, the legacy apparatus 12 can acquire the RTS information, and the non-legacy apparatus 11 can acquire both the RTS information and the allocation information.

As described above, the non-legacy apparatus 11-1 controls the transmission of the RTS trigger frame, and the non-legacy apparatus 11-2 controls the reception of that RTS trigger frame. Therefore, the legacy apparatus 12 can be prevented from interfering with RTA data communication due to transmitting data during the R-TWT SP period. As a result, high reliability of wireless communication of RTA data can be ensured when the non-legacy apparatus 11 and the legacy apparatus 12 that perform wireless communication in the same frequency band are mixed. In other words, the non-legacy apparatus 11 can efficiently perform RTA data communication using the R-TWT technology.

### 2. Second Embodiment

### Description of Real-Time Parameter Exchange Processing

A second embodiment of the wireless communication system to which the present technology is applied is different from the first embodiment mainly in the real-time parameter exchange processing, in that the RTS trigger frame is not transmitted, and in that the CTS frame is replaced with a CTS trigger frame, and is similar to the first embodiment in the other points. Therefore, hereinafter, parts different from those of the second embodiment will be focused. Note that the apparatuses, modules, and sections of the wireless communication system 10 of the second embodiment are denoted by the same reference symbols as those in the first embodiment.

FIG. 22 is a flowchart for describing real-time parameter exchange processing.

In the real-time parameter exchange processing of FIG. 22, the non-legacy apparatus 11-1 transmits a Real Time Parameter Setup Request frame, and the non-legacy apparatus 11-2 transmits a Real Time Parameter Setup Response frame.

Specifically, in Step S361 of FIG. 22, the transmission controller 57 of the non-legacy apparatus 11-2 transmits the encoded data of the Real Time Parameter Setup Request frame to the non-legacy apparatus 11-1 via the antenna section 59. The Real Time Parameter Setup Request frame includes real-time parameters that are calculated by the RTA management section 53 and the transmission opportunity management section 55 and supplied to the transmission controller 57 via the access controller 58.

In Step S371, the reception controller 60 of the non-legacy apparatus 11-1 receives the Real Time Parameter Setup Request frame transmitted by the processing of Step S361 via the antenna section 59. The reception controller 60 supplies the real-time parameters included in that Real Time Parameter Setup Request frame to the transmission opportunity management section 55 and the RTA management section 53 via the access controller 58. On the basis of those real-time parameters, the transmission opportunity management section 55 sets adaptable real-time parameters. The transmission opportunity management section 55 supplies the set real-time parameters to the transmission controller 57 via the access controller 58.

In Step S372, the transmission controller 57 transmits the encoded data of a Real Time Parameter Response frame that includes those real-time parameters to the non-legacy apparatus 11-2 via the antenna section 59.

In Step S362, the reception controller 60 receives the Real Time Parameter Setup Response frame transmitted by the processing of Step S372 via the antenna section 59. The reception controller 60 supplies the real-time parameters included in the Real Time Parameter Setup Request frame to the transmission opportunity management section 55 via the access controller 58. On the basis of those real-time parameters, the transmission opportunity management section 55 sets real-time parameters. The real-time parameter exchange processing then ends.

### Description of Another Example of Communication Operation for RTA Data Performed Using R-TWT Technology Without Considering Legacy Apparatus

FIG. 23 is a timing chart for describing another example of a communication operation for RTA data performed within the R-TWT SP period in the communication operation of FIG. 7.

The upper row of FIG. 23 indicates an operation of the reception apparatus, and the lower row indicates an operation of the transmission apparatus.

As shown in the upper row of FIG. 23, when the R-TWT SP period starts, the reception apparatus transmits a trigger frame for transmitting RTA data. As shown in the lower row of FIG. 23, the transmission apparatus receives that trigger frame and starts to transmit RTA data. As shown in the upper row of FIG. 23, the reception apparatus receives that RTA data, and after the reception, returns a BA frame to the transmission apparatus. As shown in the lower row of FIG. 23, the transmission apparatus receives that BA frame from the reception apparatus.

Note that, in FIG. 23, for example, the reception apparatus can operate as an access point, and the transmission apparatus can operate as a station. In this case, the RTA data is uplink data.

In the example of FIG. 23, the reception apparatus transmits the trigger frame, and thus causes the transmission apparatus to start the transmission of RTA data, but the legacy apparatus cannot interpret the trigger frame. Therefore, similarly to the cases described in FIG. 7 and FIG. 8, when the communication of RTA data is performed using the R-TWT technology without considering the legacy apparatuses, that communication is subject to interference from the communication of the legacy apparatuses. This impairs the reliability of the communication of RTA data. In this regard, also in the second embodiment, the wireless communication system 10 performs communication using the R-TWT technology by considering the legacy apparatuses 12, similarly to the first embodiment.

### Description of Communication Operation Using R-TWT Technology by Wireless Communication System

FIG. 24 is a timing chart showing an example of a communication operation using the R-TWT technology by the wireless communication system 10.

The non-legacy apparatuses 11-1 and 11-2 perform the real-time parameter exchange processing shown in FIG. 22 and shares the real-time parameters before performing a communication operation using the R-TWT technology. Therefore, as shown in the first and fourth rows of FIG. 24, the R-TWT SP period set on the basis of the real-time parameters shared by the non-legacy apparatuses 11-1 and 11-2 are the same.

When the first R-TWT SP period starts, as shown in the third row of FIG. 24, the non-legacy apparatus 11-2 transmits a CTS trigger frame represented by C in FIG. 24. The CTS trigger frame is a control frame in which CTS information included in a CTS (CTS-Self) frame and allocation information included in a trigger frame are disposed to be associated with each other. The CTS information is one of the legacy information for legacy apparatuses 12, which can be interpreted by both the non-legacy apparatus 11 and the legacy apparatus 12.

As shown in the second row of FIG. 24, the non-legacy apparatus 11-1 receives that CTS trigger frame and understands that it is prompted to transmit the RTA data addressed thereto. The non-legacy apparatus 11-1 understands resource information or the like that is allocated to the RTA data addressed to the non-legacy apparatus 11-2 by the allocation information included in the CTS trigger frame.

As shown in the second row of FIG. 24, the non-legacy apparatus 11-1 transmits the RTA data corresponding to the CTS trigger frame to the non-legacy apparatus 11-2, and as shown in the third row of FIG. 24, the non-legacy apparatus 11-2 receives that RTA data.

Meanwhile, as shown in the fifth row of FIG. 24, the legacy apparatus 12-2 also receives the CTS trigger frame and acquires CTS information included in that CTS trigger frame. The legacy apparatus 12-2 then sets NAV for the period from the current time to the time indicated by Duration included in the CTS information, which is indicated by the arrow in FIG. 24. This prevents the legacy apparatus 12-2 from performing transmission until the first R-TWT SP period ends, so that the non-legacy apparatus 11-2 can receive the RTA data reliably.

After the end of the first R-TWT SP period, in the example in FIG. 24, the non-legacy apparatus 11-2 transmits data other than the RTA data as shown in the third row of FIG. 24, and the non-legacy apparatus 11-1 receives that data as shown in the second row of FIG. 24.

Also at the start of the second R-TWT SP period, the non-legacy apparatus 11-2 transmits a CTS trigger frame in the same way as at the start of the first R-TWT SP period. However, at that time, if the transmission path of the non-legacy apparatus 11-1 is in a BUSY state as shown in the second row of FIG. 24, it is difficult for the non-legacy apparatus 11-1 to detect the CTS trigger frame. Therefore, the non-legacy apparatus 11-2 does not transmit the RTA data. On the other hand, as shown in the fifth row of FIG. 24, the legacy apparatus 12-2 sets NAV as in the case of the first R-TWT SP period.

As shown in the third row of FIG. 24, the non-legacy apparatus 11-2 transmits a CF-END frame represented by E in FIG. 24 because no RTA data is transmitted from the non-legacy apparatus 11-1. As shown in the fifth row of FIG. 24, the legacy apparatus 12-2 receives that CF-END frame and releases the NAV. This allows the transmission path to be used for communication other than the RTA data communication between the non-legacy apparatuses 11-1 and 11-2, thereby improving the utilization efficiency of the transmission path.

If the BUSY state is resolved within the R-TWT SP period, as shown in the second row of FIG. 24, the non-legacy apparatus 11-1 transmits RTA data, and as shown in the third row of FIG. 24, the non-legacy apparatus 11-2 receives that RTA data.

As described above, the non-legacy apparatus 11-1 transmits RTA data after the BUSY state is resolved, so that the delay in transmission of RTA data can be suppressed. Note that the non-legacy apparatus 11-2 may transmit RTA data immediately after the BUSY state is resolved, or it may transmit RTA data after a predetermined time elapses after the BUSY state is resolved. However, since NAV is released at the legacy apparatus 12-2 at that time, data may be transmitted from the legacy apparatus 12-2.

Also at the start of the third R-TWT SP period, the non-legacy apparatus 11-2 wants to transmit a CTS trigger frame in the same way as at the start of the first R-TWT SP period, but the transmission path may be in a BUSY state as shown in the third row of FIG. 24. In this case, the non-legacy apparatus 11-2 does not transmit the CTS trigger frame until the BUSY state is resolved. Therefore, as shown in the fifth row of FIG. 24, the legacy apparatus 12-2 can transmit any data. Note that the non-legacy apparatus 11-1 can also transmit any data.

If the BUSY state is resolved within the second R-TWT SP period, the non-legacy apparatus 11-1 transmits a CTS trigger frame to the non-legacy apparatus 11-2. The operation after this is the same as that of the first R-TWT SP period, and thus the description thereof will be omitted.

As described above, the non-legacy apparatus 11-1 can notify the non-legacy apparatus 11-2 of the state where it can receive RTA data by transmitting a CTS trigger frame after the BUSY state is resolved. Thus, the non-legacy apparatus 11-2 transmits RTA data, so that the delay in transmission of RTA data can be suppressed. Note that the non-legacy apparatus 11-1 may transmit the CTS trigger frame immediately after the BUSY state is resolved, or it may transmit the CTS trigger frame after a predetermined time elapses after the BUSY state is resolved.

The operation of the fifth R-TWT SP period is the same as that of the first R-TWT SP period, and thus the description thereof will be omitted.

Note that Duration in the CTS information included in the CTS trigger frame may indicate the time until the end of the reception of RTA data, rather than the time until the end of the R-TWT SP period. In this case, the pressure on communication other than the RTA data communication on the transmission path can be suppressed. In the example in FIG. 24, if the start of the transmission of the RTA data is delayed due to the BUSY state of the transmission path, only the RTA data that can be transmitted by the end of the R TWT SP period among the RTA data planned to be transmitted is transmitted, but all the RTA data planned to be transmitted may be transmitted.

As described above, the non-legacy apparatus 11-2 transmits the CTS trigger frame that includes CTS information and allocation information. Therefore, the legacy apparatus 12-2 can set NAV in accordance with the CTS information. Therefore, the legacy apparatus 12-2 can be prevented from interfering with the RTA data communication due to transmitting data during the R-TWT SP period. As a result, the transmission of RTA data can be prioritized in a stable manner. Therefore, the reliability of low latency transmission of RTA data is improved.

### Description of Communication Operation for RTA Data in Wireless Communication System

FIG. 25 is a timing chart for describing a communication operation for RTA data performed within the R-TWT SP period in the communication operation of FIG. 24.

The upper row of FIG. 25 indicates an operation of the non-legacy apparatus 11-2, and the lower row indicates an operation of the non-legacy apparatus 11-1.

As shown in the upper row of FIG. 25, when the R-TWT SP period starts, the non-legacy apparatus 11-2 transmits the CTS trigger frame. As shown in the lower row of FIG. 25, the non-legacy apparatus 11-1 receives that CTS trigger frame and transmits RTA data if it can transmit RTA data.

As shown in the upper row of FIG. 25, the non-legacy apparatus 11-2 receives that RTA data and after the reception of the RTA data, returns a BA frame to the non-legacy apparatus 11-1. As shown in the lower row of FIG. 25, the non-legacy apparatus 11-1 receives that BA frame.

Note that, similarly to the first embodiment, if the remaining period before the end of the R-TWT SP period is a predetermined period or more, the non-legacy apparatus 11-2 can transmit a CF-END frame in conjunction with the BA frame. Similarly to the first embodiment, the non-legacy apparatus 11-2 may transmit the CF-END frame in conjunction with the BA frame or may transmit only the BA frame, regardless of whether the remaining period before the end of the R-TWT SP period is a predetermined period or more. The non-legacy apparatus 11-2 may also transmit only the CF-END frame.

If the non-legacy apparatus 11-1 operates as a station, and the non-legacy apparatus 11-2 operates as an access point in FIG. 25, the RTA data is uplink data.

### Description of RTA Data Communication Processing

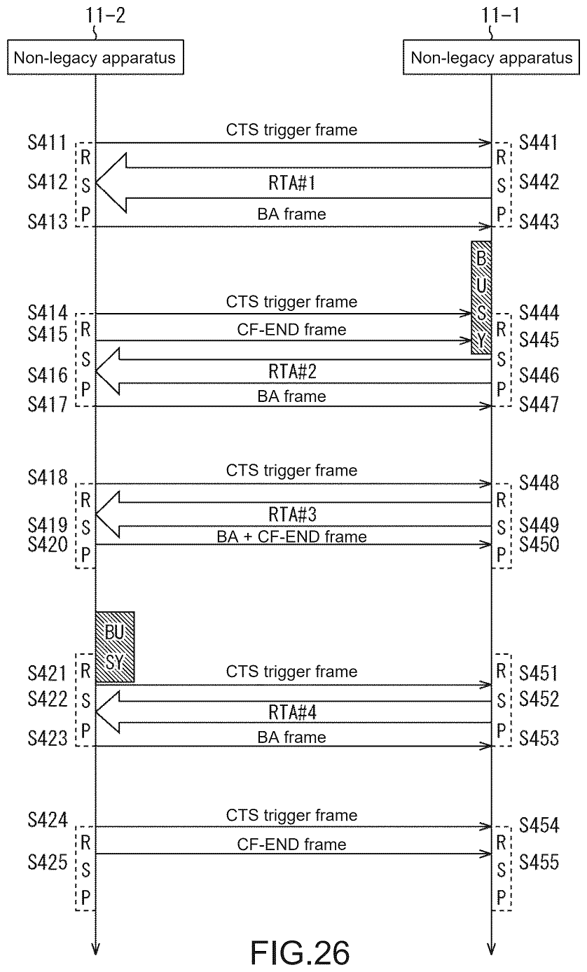

FIG. 26 is a flowchart for describing RTA data communication processing that is performed between the non-legacy apparatuses 11-1 and 11-2 to transmit and receive RTA data by using the R-TWT technology.

In the R-TWT SP period indicated by the dotted-line rectangle in which RSP is described in FIG. 26, when the first R-TWT SP period starts, the transmission controller 57 of the non-legacy apparatus 11-2 performs processing of Step S411 in FIG. 26. Specifically, in Step S411, the transmission controller 57 transmits the encoded data of the CTS trigger frame constructed by the control frame construction section 56 to the non-legacy apparatus 11-1 via the antenna section 59.

In Step S441, the reception controller 60 of the non-legacy apparatus 11-1 receives the encoded data of the CTS trigger frame transmitted in Step S411 via the antenna section 59.

In Step S442, the transmission controller 57 transmits the encoded data of RTA #1 constructed by the data frame construction section 54 in accordance with the CTS trigger frame to the non-legacy apparatus 11-2 via the antenna section 59.

In Step S412, the reception controller 60 receives the encoded data of RTA #1 transmitted in Step S442 via the antenna section 59. If the remaining period from the completion of reception of the encoded data of RTA #1 until the end of the first R-TWT SP period is not a predetermined period or more, the transmission controller 57 performs processing of Step S413. Specifically, in Step S413, the transmission controller 57 transmits the BA frame constructed by the control frame construction section 56 in response to the completion of reception of the encoded data of RTA #1 to the non-legacy apparatus 11-1 via the antenna section 59.

In Step S443, the reception controller 60 receives the BA frame transmitted in Step S413 via the antenna section 59.

When the second R-TWT SP period starts, in Step S414, the transmission controller 57 transmits the CTS trigger frame to the non-legacy apparatus 11-1, similarly to the processing of Step S411.

In Step S444, the reception controller 60 receives the encoded data of the CTS trigger frame transmitted in Step S414, similarly to the processing of Step S441. However, at that time, if the transmission path of the non-legacy apparatus 11-1 is in a BUSY state, the encoded data of that CTS trigger frame cannot be decoded accurately. Therefore, the non-legacy apparatus 11-1 waits until the BUSY state of the transmission path is resolved.

The non-legacy apparatus 11-2 performs processing of Step S415 because no encoded data of the data frame of the RTA data is returned from the non-legacy apparatus 11-1. Specifically, in Step S415, the transmission controller 57 transmits the encoded data of the CF-END frame constructed by the control frame construction section 56 via the antenna section 59. At that time, the non-legacy apparatus 11-2 may transmit the encoded data of the MAC frame addressed to apparatuses other than the non-legacy apparatus 11-1, but in the example of FIG. 26, the non-legacy apparatus 11-2 gives priority to transmitting RTA data and waits until it receives the RTA data.

In Step S445, the reception controller 60 receives the encoded data of the CF-END frame transmitted in Step S415. However, at that time, if the transmission path of the non-legacy apparatus 11-1 is in a BUSY state, the encoded data of the CF-END frame cannot be decoded accurately. Therefore, the non-legacy apparatus 11-1 waits until the BUSY state of the transmission path is resolved.

When the BUSY state of the transmission path of the non-legacy apparatus 11-1 is resolved, the non-legacy apparatus 11-1 presumes that the CTS trigger frame has been transmitted from the non-legacy apparatus 11-2 during this BUSY state, and performs processing of Step S446. The processing of Steps S446 and S447 and Steps S416 and S417 are similar to the processing of Steps S442 and S443 and Steps S412 and S413 except that RTA #1 is replaced with RTA #2, and thus the description thereof will be omitted.

Note that in Step S446 the non-legacy apparatus 11-1 may transmit only the data frames of RTA data in RTA #2, which correspond to the amount of data that can be transmitted in the time until the end of the second R-TWT SP period.

When the third R-TWT SP period starts, the processing of Steps S418 and S419 and Steps S448 and S449 are performed. The processing of Steps S418 and S419 and Steps S448 and S449 are similar to the processing of Steps S411 and S412 and Steps of S441 and S442 except that RTA #1 is replaced with RTA #3, and thus the description thereof will be omitted.

In Step S419, if the remaining period from the completion of reception of the encoded data of RTA #3 until the end of the third R-TWT SP period is a predetermined period or more, the transmission controller 57 performs processing of Step S420. Specifically, in Step S420, the transmission controller 57 concatenates the BA frame and CF-END frame constructed by the control frame construction section 56 to be encoded in response to the completion of reception of the encoded data of RTA #3 and transmits them via the antenna section 59.

In Step S450, the reception controller 60 receives the encoded data obtained by concatenating and encoding the BA frame and the CF-END frame, which has been transmitted in Step S420, via the antenna section 59.

Next, when the fourth R-TWT SP period starts, if the transmission path of the non-legacy apparatus 11-2 is in a BUSY state, the non-legacy apparatus 11-2 waits until the BUSY state of the transmission path is resolved. When the BUSY state of the transmission path of the non-legacy apparatus 11-1 is resolved, the processing of Step S421 is performed. The processing of Steps S421 to S423 and S451 to S453 are similar to the processing of Steps S411 to S413 and S441 to S443 except that RTA #1 is replaced with RTA #4, and thus the description thereof will be omitted.

Note that the CTS trigger frame transmitted in Step S421 may correspond to the time from the transmission of the CTS trigger frame by the non-legacy apparatus 11-2 until the end of the fourth R-TWT SP period. For example, Duration in the CTS information included in the CTS trigger frame may indicate that time, and the allocation information may include resource allocation information of the amount of resources corresponding to that time. In this case, in Step S452, the non-legacy apparatus 11-1 may transmit only the data frames of RTA data in RTA #4, which correspond to the amount of data that can be transmitted in the time until the end of the fourth R-TWT SP period.

Next, when the fifth R-TWT SP period starts, the processing of Steps S424 and S454 is performed in a manner similar to the processing of Steps S411 and S441. If there is no RTA data for the fifth R-TWT SP period, the transmission controller 57 of the non-legacy apparatus 11-1 does not transmit the encoded data of the data frame of RTA data.

Therefore, in this case, no encoded data of the data frame of the RTA data is returned from the non-legacy apparatus 11-1, and thus the processing of Steps S425 and S455 similar to the processing of Step S415 and S445 is performed.

### First Configuration Example of CTS Trigger Frame

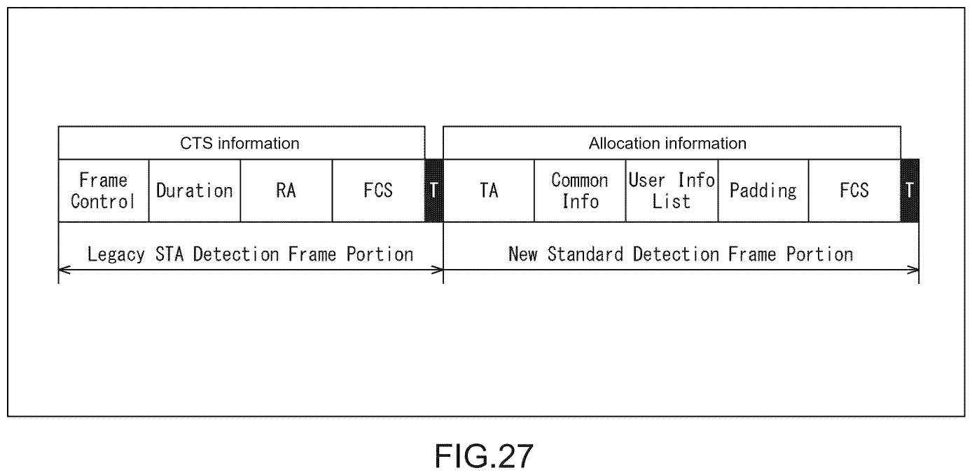

FIG. 27 is a diagram showing a first configuration example of the CTS trigger frame.

In the CTS trigger frame of FIG. 27, CTS information and allocation information are disposed as data in the same control frame, so that the CTS information and the allocation information are disposed to be associated with each other. Specifically, CTS information, Tail, allocation information, and Tail are disposed in the data in the CTS trigger frame, in order from the head. The CTS information includes Frame Control, Duration, RA, and FCS. In the second embodiment, the allocation information is information other than CTS information except for FCS in the information included as data of the trigger frame in FIG. 12. Specifically, the allocation information includes TA, Common Info, User Info List, Padding, and FCS.

The CTS trigger frame of FIG. 27 includes CTS information that can be interpreted by the legacy apparatus 12 as data, and thus the legacy apparatus 12 can acquire the CTS information. Note that Tail is disposed after the CTS information, and thus the legacy apparatus 12 can perform termination processing.

The CTS trigger frame of FIG. 27 includes CTS information and allocation information that are included in the trigger frame that can be interpreted as data by the non-legacy apparatus 11. Therefore, the non-legacy apparatus 11 can acquire the same information as when interpreting the trigger frame by acquiring the CTS information followed by the allocation information. Note that, since Tail is disposed after the allocation information, the non-legacy apparatus 11 can perform termination processing.

### Description of CTS Trigger Frame Transmission Processing

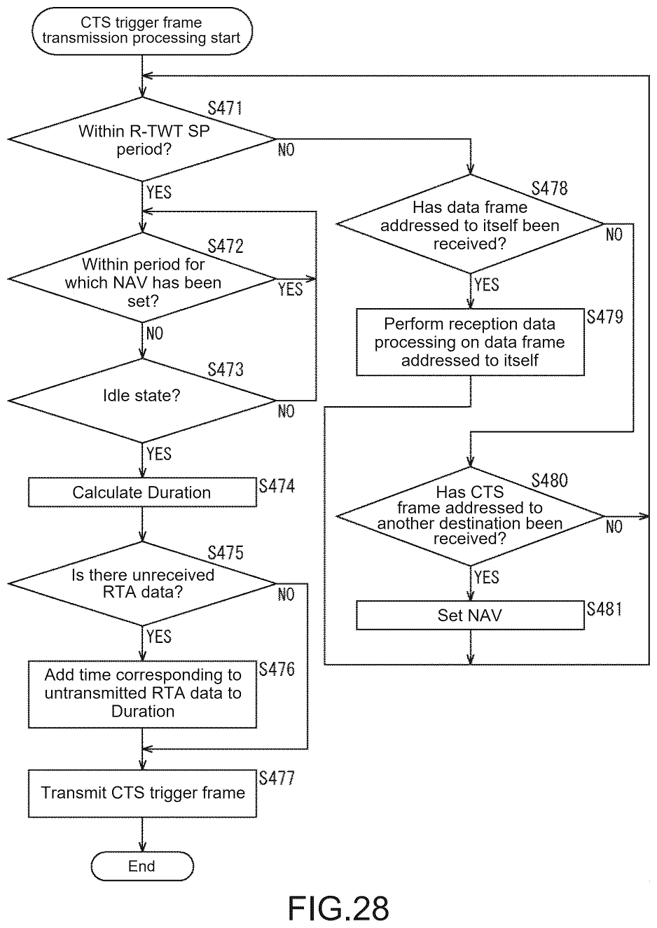

FIG. 28 is a flowchart for describing CTS trigger frame transmission processing in which the non-legacy apparatus 11-2 transmits a CTS trigger frame.

In Step S471 of FIG. 28, the transmission opportunity management section 55 of the non-legacy apparatus 11-2 determines whether or not the current time is within the R-TWT SP period. If it is determined in Step S471 that the current time is within the R-TWT SP period, the processing proceeds to Step S472.

In Step S472, the access controller 58 determines whether or not the current time is within the period for which NAV has been set. If it is determined in Step S472 that the current time is not within the period for which NAV has been set, in Step S473, the access controller 58 determines whether or not the state of the transmission path notified by the reception controller 60 is an idle state. If it is determined in Step S473 that the state is an idle state, in Step S474, the RTA management section 53 calculates the time corresponding to the RTA data to be transmitted in the current R-TWT SP period as Duration.

In Step S475, the RTA management section 53 determines whether or not there is unreceived RTA data that should have been received in the previous R-TWT SP period. If it is determined in Step S475 that there is unreceived RTA data, in Step S476, the RTA management section 53 adds the time corresponding to that unreceived RTA data to the Duration calculated in Step S474. The control frame construction section 56 then constructs a CTS trigger frame including this Duration, supplies it to the transmission controller 57, and proceeds to Step S477.

On the other hand, if it is determined in Step S475 that there is no untransmitted RTA data, the control frame construction section 56 constructs a CTS trigger frame including the Duration calculated in Step S474, supplies it to the transmission controller 57, and proceeds to Step S477.

In Step S477, the transmission controller 57 transmits the encoded data of the CTS trigger frame including the Duration calculated in Step S474 or S476 via the antenna section 59. Then, the CTS trigger frame transmission processing ends.

On the other hand, if it is determined in Step S472 that the current time is within the period for which NAV has been set, the non-legacy apparatus 11-2 waits until it is determined that the current time is not within the period for which NAV has been set. If it is determined in Step S473 that the state is not an idle state, for example, if the encoded data has been received, the processing returns to Step S472, and the subsequent processing is repeated. Note that in those cases, the processing may return to Step S471.

If it is determined in Step S471 that the current time is not within the R-TWT SP period, in Step S478, the reception controller 60 determines whether or not the encoded data of the data frame addressed to itself has been received. If it is determined in Step S478 that the encoded data of the data frame addressed to itself has been received, in Step S479, the reception controller 60 performs the reception data processing on that encoded data. The processing then returns to Step S471, and the subsequent processing is repeated.

If it is determined in Step S478 that the encoded data of a data frame addressed to itself has not been received, in Step S480, the reception controller 60 determines whether or not the encoded data of a CTS frame addressed to another destination has been received. If it is determined in Step S480 that the encoded data of a CTS frame addressed to another destination has been received, the reception controller 60 supplies that CTS frame addressed to another destination to the control frame extraction section 61 and proceeds to Step S481.

In Step S480, the access controller 58 acquires Duration extracted from the CTS frame addressed to another destination by the control frame extraction section 61, and sets NAV for the period from the current time to the time indicated by Duration. The processing then returns to Step S471, and the subsequent processing is repeated.

If it is determined in Step S480 that the encoded data of a CTS frame addressed to another destination has not been received, the processing returns to Step S471, and the subsequent processing is repeated.

### Description of RTA Data Transmission Processing

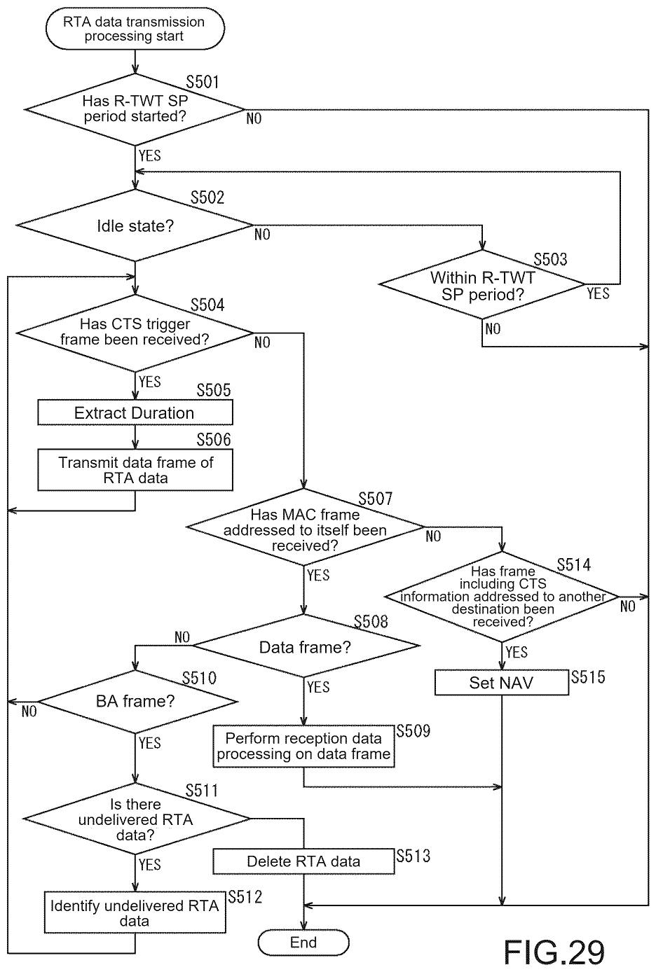

FIG. 29 is a flowchart for describing RTA data transmission processing in which the non-legacy apparatus 11-1 transmits RTA data.

In Step S501 of FIG. 29, the transmission opportunity management section 55 of the non-legacy apparatus 11-1 determines whether or not the R-TWT SP period has started. If it is determined in Step S501 that the-TWT SP period has started, in Step S502, the access controller 58 determines whether or not the state of the transmission path is an idle state. If it is determined in Step S502 that the state is not an idle state, in Step S503, the transmission opportunity management section 55 determines whether or not the current time is within the R-TWT SP period.

If it is determined in Step S503 that the current time is within the R-TWT SP period, the processing returns to Step S502, and the processing of Steps S502 and S503 are repeated until the transmission path transitions to the idle state or the R-TWT SP period ends.

On the other hand, if it is determined in Step S502 that the state is an idle state, in Step S504, the reception controller 60 determines whether or not the encoded data of the CTS trigger frame addressed to itself, which has been transmitted from the non-legacy apparatus 11-2, has been received. If it is determined in Step S504 that the encoded data of the CTS trigger frame has been received, the reception controller 60 supplies that CTS trigger frame to the control frame extraction section 61.

In Step S505, the control frame extraction section 61 extracts information such as Duration included in the CTS trigger frame and supplies it to the RTA management section 53 via the transmission opportunity management section 55 as necessary. The data frame construction section 54 acquires the RTA data corresponding to the time indicated y by Duration among the RTA data to be transmitted in the current R-TWT SP period from the transmission buffer 52, constructs a data frame of that RTA data, and supplies it to the transmission controller 57.

In Step S506, the transmission controller 57 then transmits the encoded data of the data frame of that RTA data to the non-legacy apparatus 11-2 via the antenna section 59. The processing then returns to Step S504, and the subsequent processing is repeated.

On the other hand, if it is determined in Step S504 that the encoded data of the CTS trigger frame has not been received, in Step S507, the reception controller 60 determines whether or not the encoded data of a MAC frame addressed to itself has been received. If it is determined in Step S507 that the encoded data of a MAC frame addressed to itself has been received, the processing proceeds to Step S508.

In Step S508, the reception controller 60 determines whether or not the MAC frame addressed to itself is a data frame. If it is determined in Step S508 that the MAC frame addressed to itself is a data frame, in Step S509, the non-legacy apparatus 11-1 performs the reception data processing on the encoded data of that data frame, and terminates the RTA data transmission processing.

On the other hand, if it is determined in Step S508 that the MAC frame addressed to itself is not a data frame, in Step S510, the reception controller 60 determines whether or not the encoded data of the received MAC frame addressed to itself is encoded data of a BA frame. If it is determined in Step S510 that the encoded data of the received MAC frame is encoded data of a BA frame, the reception controller 60 supplies that BA frame to the control frame extraction section 61. The control frame extraction section 61 extracts information included in the BA frame and supplies that information to the RTA management section 53 via the transmission opportunity management section 55 as necessary.

In Step S511, the RTA management section 53 then determines whether or not there is undelivered RTA data on the basis of the information included in the BA frame. If it is determined in Step S511 that there is undelivered RTA data, in Step S512, the RTA management section 53 identifies the undelivered RTA data. The processing then returns to Step S504, the subsequent processing is repeated.

If it is determined in Step S511 that there is no undelivered RTA data, in Step S513, the RTA management section 53 deletes the RTA data that has been transmitted from the transmission buffer 52, and terminates the RTA data transmission processing.

On the other hand, if it is determined in Step S507 that the encoded data of a MAC frame addressed to itself has not been received, the processing proceeds to Step S514. In Step S514, the reception controller 60 determines whether or not the encoded data of a CTS frame or CTS trigger frame including CTS information addressed to another destination has been received.

If it is determined in Step S514 that the encoded data of a CTS frame or CTS trigger frame addressed to another destination has been received, the reception controller 60 supplies that CTS trigger frame to the control frame extraction section 61. The control frame extraction section 61 extracts information such as Duration included in the CTS trigger frame and supplies it to the access controller 58. In Step S515, the access controller 58 then sets NAV for the period from the current time to the time indicated by Duration. The RTA data transmission processing then ends.

On the other hand, if it is determined in Step S514 that the encoded data of a CTS frame or CTS trigger frame addressed to another destination has not been received, the RTA data transmission processing ends. If it is determined in Step S501 that the R-TWT SP period has not started, or if it is determined in Step S503 that the current time is not within the R-TWT SP period, the RTA data transmission processing ends.

Note that, in the example of FIG. 29, the Duration of the CTS trigger frame is assumed to be larger than 0, but if the Duration is 0, that is, if there is no RTA data to be transmitted within the current R-TWT SP period, the processing of Step S506 is not performed.

### Description of RTA Data Reception Processing

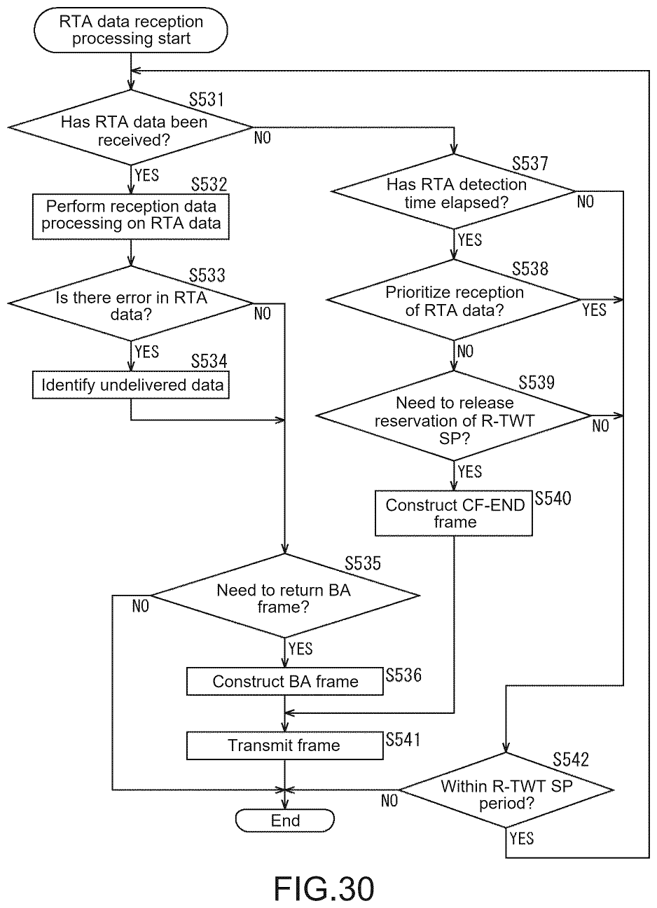

FIG. 30 is a flowchart for describing RTA data reception processing in which the non-legacy apparatus 11-2 receives RTA data.

In Step S531 of FIG. 30, the reception controller 60 determines whether or not the encoded data of a data frame of RTA data addressed to itself has been received. If it is determined in Step S531 that the encoded data of a data frame of RTA data addressed to itself has been received, in Step S532, the non-legacy apparatus 11-2 performs the reception data processing on the encoded data.

In Step S533, the non-legacy apparatus 11-2 determines whether or not there is an error in the received encoded data of the data frame of the RTA data, that is, an error has occurred in the reception data processing. If it is determined in Step S533 that there is an error, in Step S534, the non-legacy apparatus 11-2 identifies the RTA data in which an error has occurred, as undelivered data. The processing then proceeds to Step S535.

On the other hand, if it is determined in Step S533 that there is no error, the processing proceeds to Step S535.

In Step S535, the transmission opportunity management section 55 determines whether to need to return a BA frame. If it is determined in Step S535 that a BA frame needs to be returned, in Step S536, the control frame construction section 56 constructs a BA frame. Note that if the undelivered data is identified in Step S534, this BA frame includes information for identifying that undelivered data. The control frame construction section 56 supplies the BA frame to the transmission controller 57 and proceeds to Step S541.

On the other hand, if it is determined in Step S535 that the BA frame does not need to be returned, the RTA data reception processing ends.

If it is determined in Step S531 that the encoded data of a data frame of RTA data addressed to itself has not been received, the processing proceeds to Step S537. In Step S537, the non-legacy apparatus 11-2 determines whether or not an RTA detection time, which is assumed as the time from the transmission of the CTS trigger frame by itself to the reception of the RTA data, has elapsed.

If it is determined in Step S537 that the RTA detection time has elapsed, in Step S538, the access controller 58 determines whether to prioritize transmission of the RTA data. If it is determined in Step S538 that transmission of RTA data is not prioritized, that is, the transmission path is to be used effectively, the processing proceeds to Step S539.

In Step S539, the access controller 58 determines whether to need to release the reservation of the R-TWT SP. If it is determined in Step S539 that the release of the reservation of the R-TWT SP is necessary, in Step S540, the control frame construction section 56 constructs a CF-END frame and supplies it to the transmission controller 57. The processing then proceeds to Step S541.

In Step S541, the transmission controller 57 transmits the encoded data of the BA frame constructed in Step S536 or of the CF-END frame constructed in Step S540 via the antenna section 59. The RTA data reception processing then ends.

On the other hand, if it is determined in Step S537 that the RTA detection time has not elapsed, the processing proceeds to Step S542. If it is determined in Step S538 that the transmission of RTA data is prioritized, the processing proceeds to Step S542. If it is determined in Step S539 that it is unnecessary to release the reservation of the R-TWT SP, the processing proceeds to Step S542.

In Step S542, the transmission opportunity management section 55 determines whether or not the current time is within the R-TWT SP period. If it is determined in Step S542 that the current time is within the R-TWT SP period, the processing returns to Step S531, and the subsequent processing is performed.

On the other hand, if it is determined in Step S542 that the current time is not within the R-TWT SP period, the RTA data reception processing ends.

As described above, if it is determined in Step S538 that the reception of RTA data is prioritized, the processing proceeds to Step S342. Therefore, the non-legacy apparatus 11-2 continues to wait until the encoded data of a data frame of RTA data addressed to itself is received within the R-TWT SP period.

Note that in the above description the CTS trigger frame is assumed to be a control frame in which CTS information and allocation information are associated with each other, but it can be a frame other than a control frame as long as it is a frame in which CTS information and allocation information are associated with each other. For example, the CTS trigger frame may be a frame such as an A-MPDU, a PPDU, an A-PPDU, a concatenated PPDU, or a frequency-multiplexed PPDU.

### Second Configuration Example of CTS Trigger Frame

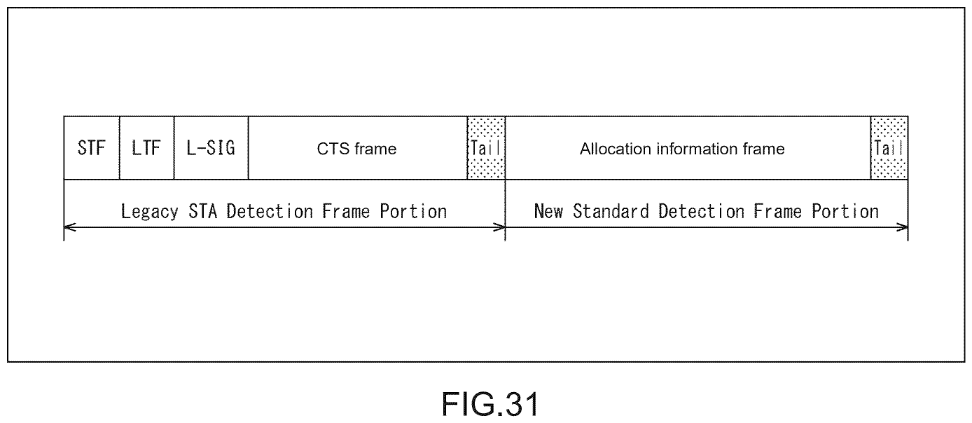

FIG. 31 is a diagram showing a configuration example of the CTS trigger frame as an A-MPDU.

The CTS trigger frame of FIG. 31 is an A-MPDU in which CTS information and allocation information are separately changed into MAC frames and aggregated, so that the CTS information and the allocation information are disposed to be associated with each other. Specifically, the CTS trigger frame of FIG. 31 includes one PLCP preamble, a CTS frame, Tail, an allocation Information frame, and Tail, in order from the head.

Since the CTS trigger frame of FIG. 31 includes a CTS frame that can be interpreted by the legacy apparatus 12, the legacy apparatus 12 can acquire CTS information. The CTS trigger frame also includes an allocation information frame corresponding to the trigger frame that can be interpreted by the non-legacy apparatus 11, and thus the non-legacy apparatus 11 can acquire both the CTS information and the allocation information.

### Third Configuration Example of CTS Trigger Frame

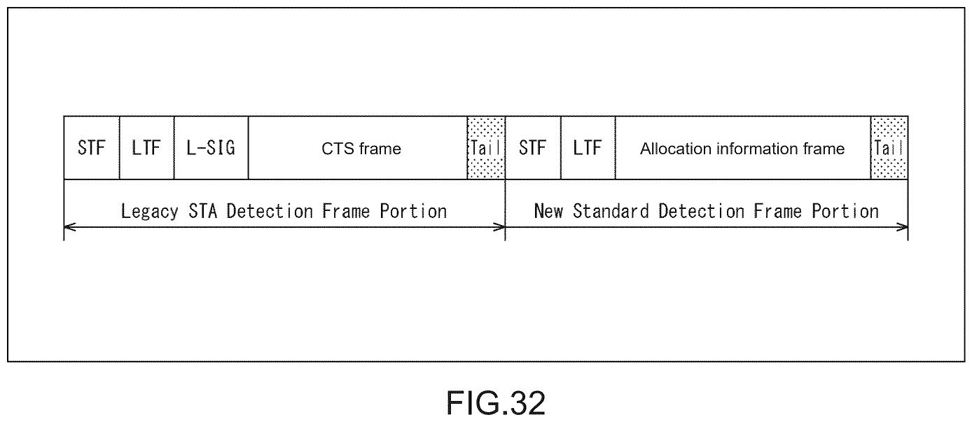

FIG. 32 is a diagram showing a configuration example of the CTS trigger frame as an A-PPDU.

The CTS trigger frame of FIG. 32 is an A-PPDU in which CTS information and allocation information are separately changed into PPDUs and aggregated, so that the CTS information and the allocation information are disposed to be associated with each other. Specifically, the CTS trigger frame of FIG. 32 includes a CTS information part (legacy portion) and an allocation information part that are concatenated and disposed via Tail. The CTS information part includes a PLCP preamble and a CTS frame. The allocation information part of the CTS trigger frame includes STF and LTF in the PLCP preamble and an allocation information frame. The period of this Tail is, for example, shorter than the SIFS period. Tail is disposed at the end of the allocation information frame.

The CTS trigger frame of FIG. 32 includes a CTS frame and an allocation information frame. Therefore, similarly to the case of FIG. 31, the legacy apparatus 12 can acquire the CTS information, and the non-legacy apparatus 11 can acquire both the CTS information and the allocation information.

### Fourth Configuration Example of CTS Trigger Frame

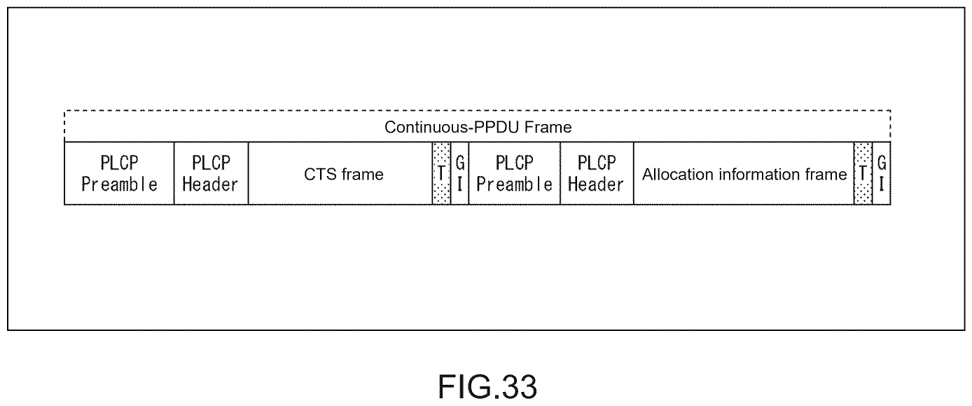

FIG. 33 is a diagram showing a configuration example of the CTS trigger frame as a concatenated PPDU.

The CTS trigger frame of FIG. 33 is a concatenated PPDU in which a CTS frame and an allocation information frame are separately changed into PPDUs and concatenated, so that CTS information and allocation information are disposed to be associated with each other. Specifically, the CTS trigger frame of FIG. 33 includes a CTS PPDU (legacy frame) and an allocation information PPDU that are concatenated via GI. The CTS PPDU includes a PLCP preamble, a PLCP header, a CTS frame, and Tail. GI is also disposed at the end of the allocation information PPDU.

The CTS trigger frame of FIG. 33 includes the CTS frame and the allocation information frame. Therefore, as in the case of FIG. 31, the legacy apparatus 12 can acquire the CTS information, and the non-legacy apparatus 11 can acquire both the CTS information and the allocation information.

### Fifth Configuration Example of CTS Trigger Frame

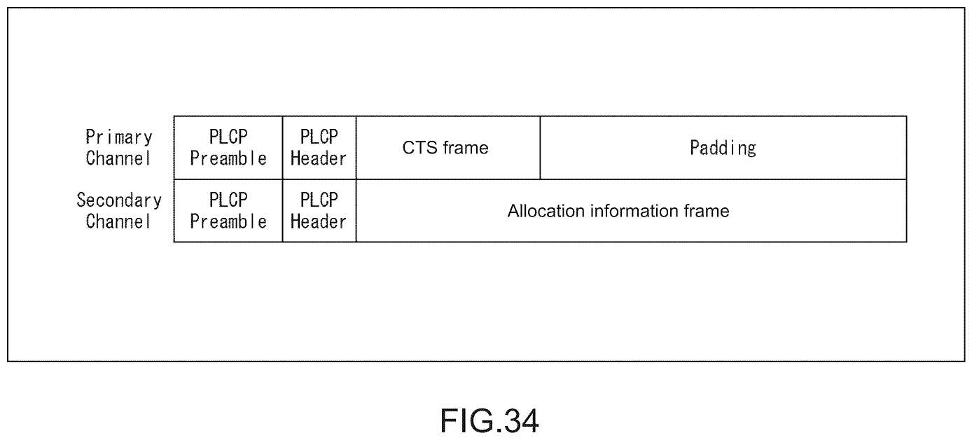

FIG. 34 is a diagram showing a configuration example of the CTS trigger frame as a frequency-multiplexed PPDU.

The CTS trigger frame of FIG. 34 is a PPDU in which a CTS frame and an allocation information frame are separately changed into PPDUs and multiplexed in the frequency direction, so that CTS information and allocation information are disposed to be associated with each other. Specifically, the CTS trigger frame of FIG. 34 is configured by multiplexing a PPDU of a main channel in which a CTS frame is disposed and a PPDU of a sub-channel in which an allocation information frame is disposed. The PPDU of the main channel includes a PLCP preamble, a PLCP header, and a CTS frame. The PPDU of the sub-channel includes a PLCP preamble, a PLCP header, and an allocation information frame.

Note that if the PPDU of the main channel and the PPDU of the sub-channel are different in information length, Padding is added to the shorter PPDU. In the example shown in FIG. 34, the information length of the PPDU of the main channel is shorter than that of the PPDU of the sub-channel, and Padding is added to the PPDU of the main channel.

The CTS trigger frame of FIG. 34 includes the CTS frame and the allocation information frame. Therefore, as in the case of FIG. 31, the legacy apparatus 12 can acquire the CTS information, and the non-legacy apparatus 11 can acquire both the CTS information and the allocation information.

As described above, the non-legacy apparatus 11-2 controls the transmission of the CTS trigger frame, and the non-legacy apparatus 11-1 controls the reception of that CTS trigger frame. Therefore, the legacy apparatus 12 can be prevented from interfering with RTA data communication due to transmitting data during the R-TWT SP period. As a result, high reliability of wireless communication of RTA data can be ensured when the non-legacy apparatus 11 and the legacy apparatus 12 that perform wireless communication in the same frequency band are mixed.

In the second embodiment, the non-legacy apparatus 11-2 that receives RTA data transmits a CTS trigger frame. Therefore, even if the non-legacy apparatus 11-2 is a subject of wireless communication, such as an access point from which the Real Time Parameter Setup Request frame is transmitted, the low latency transmission of RTA data can be performed reliably. As a result, for example, even if the RTA is an application that uploads data to a server, the data can be reliably transmitted as RTA data with low latency.

Note that the allocation information may be configured by all information included as data in the trigger frame.

The setup request element or the setup response element may be set to an action frame, and real-time parameters may be exchanged at any timing.

### 3. Computer

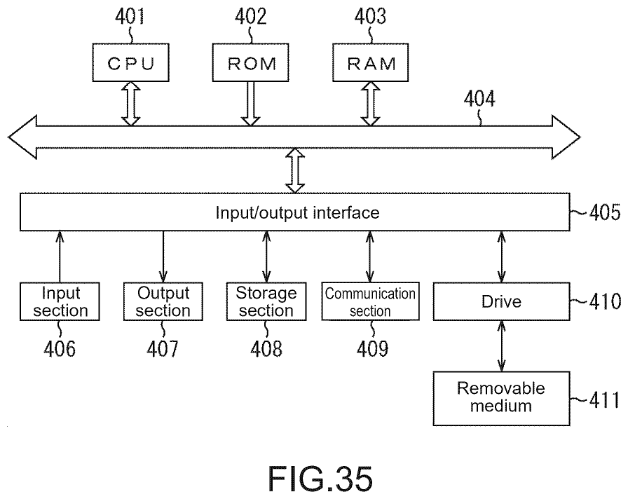

FIG. 35 is a block diagram showing a hardware configuration example of a computer that executes the series of processing described above with a program.

In the computer, a central processing unit (CPU) 401, a read only memory (ROM) 402, and a random access memory (RAM) 403 are mutually connected by a bus 404.

In addition, an input/output interface 405 is connected to the bus 404. Connected to the input/output interface 405 are an input section 406, an output section 407, a storage section 408, a communication section 409, and a drive 410.

The input section 406 includes a keyboard, a mouse, a microphone, and the like. The output section 407 includes a display, a speaker, and the like. The storage section 408 includes a hard disk, a nonvolatile memory, and the like. The communication section 409 includes a network interface and the like. The drive 410 drives a removable medium 411 such as a magnetic disk, an optical disc, a magneto optical disk, or a semiconductor memory.

In the computer configured as described above, the series of processing described above is performed by the CPU 401, for example, loading a program stored in the storage section 408 to the RAM 403 via the input/output interface 405 and the bus 404 and executing the program.

Programs to be executed by the computer (CPU 401) can be provided, for example, by being recorded on the removable medium 411 as packaged media. Programs can also be provided via a wired or wireless transmission medium such as a local area network, the Internet, or digital satellite broadcasting.

In the computer, a program can be installed on the storage section 408 via the input/output interface 405 by mounting the removable medium 411 to the drive 410. Programs can also be received by the communication section 409 via a wired or wireless transmission medium and installed on the storage section 408. Other programs can be installed in advance on the ROM 402 or the storage section 408.

Note that the programs to be executed by the computer may be programs that are processed chronologically according to the order described herein, or may be programs that are processed in parallel or at the necessary timing, such as when a call is made.

### 4. Smartphone

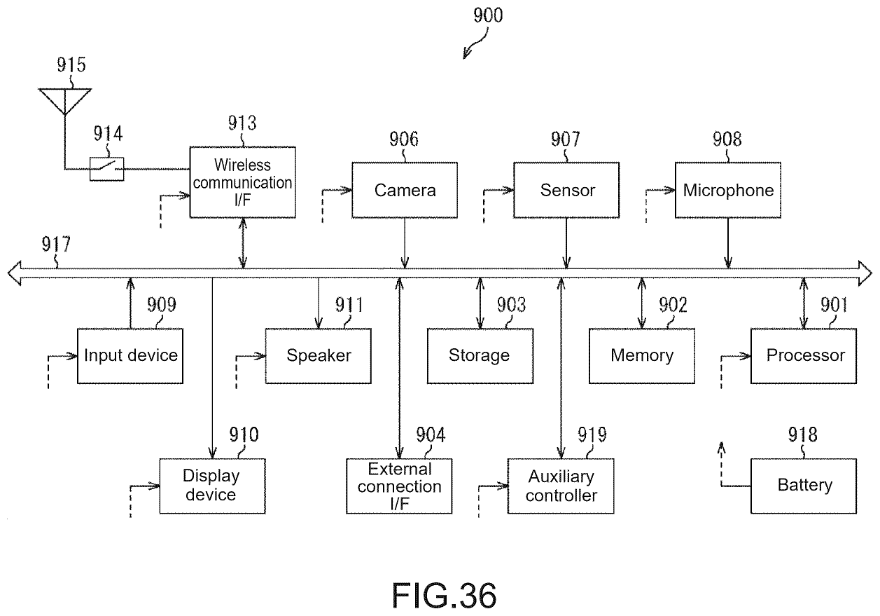

FIG. 36 is a block diagram showing a schematic configuration example of a smartphone to which the present technology is applied.

A smartphone 900 includes a processor 901, a memory 902, a storage 903, an external connection interface 904, a camera 906, a sensor 907, a microphone 908, an input device 909, and a display device 910. Further, the smartphone 900 includes a speaker 911, a wireless communication interface 913, an antenna switch 914, an antenna 915, a bus 917, a battery 918, and an auxiliary controller 919.

The processor 901 may be, for example, a CPU or SoC (System on Chip) and limits the functions of the application layer and other layers of the smartphone 900.

The memory 902 includes an RAM and a ROM and stores programs and data to be executed by the processor 901.

The storage 903 includes a storage medium such as a semiconductor memory or a hard disk.

The external connection interface 904 is an interface for connecting an external device such as a memory card or a universal serial bus (USB) device to the smartphone 900.

The camera 906 includes an imaging device such as a charge coupled device (CCD) or a complementary metal oxide semiconductor (CMOS), and generates a captured image.

The sensor 907 includes a sensor group of, for example, a positioning sensor, a gyro sensor, a geomagnetic sensor, and an acceleration sensor.

The microphone 908 converts sounds input to the smartphone 900 into audio signals.

The input device 909 includes, for example, a touch sensor that detects touch on the screen of the display device 910, a keypad, a keyboard, buttons, or switches to accept operations or information input from the user.

The display device 910 includes a screen such as a liquid crystal display (LCD) or organic light emitting diode (OLED) display, and converts audio signals output from the smartphone 900 into sounds.

The wireless communication interface 913 supports one or more of the wireless LAN standards, such as IEEE802.11a, 11b, 11g, 11ac, 11ad, 11ax, and 11be and their successor standards, to perform wireless communication.

The wireless communication interface 913 communicates with other apparatuses via a wireless LAN AP in an infrastructure mode. Further, the wireless communication interface 913 communicates directly with other apparatuses in the ad hoc mode or a direct communication mode such as Wi-Fi Direct.

Note that in Wi-Fi Direct, unlike the ad hoc mode, one of the two terminals operates as the AP, but communication is directly performed between those terminals.

The wireless communication interface 913 typically includes a baseband processor, radio frequency (RF) circuitry, and a power amplifier. The wireless communication interface 913 may be a single-chip module that integrates a memory that stores a communication control program, a processor that executes the program, and associated circuitry.

The wireless communication interface 913 may support, in addition to the wireless LAN method, other types of wireless communication methods such as a short-range wireless communication method, a near field communication method, and a cellular communication method.

The antenna switch 914 switches the connection destination of the antenna 915 between a plurality of circuits (for example, circuits for different wireless communication methods) included in the wireless communication interface 913.

The antenna 915 includes one or a plurality of antenna elements (for example, multiple antenna elements constituting a multiple input multiple output (MIMO) antenna) and is used for transmission and reception of wireless signals by the wireless communication interface 913.

Note that the smartphone 900 is not limited to the example of FIG. 36 and may include a plurality of antennas (for example, antennas for wireless LAN and antennas for proximity wireless communication methods). In such a case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to each other.

The battery 918 supplies power to each block of the smartphone 900 shown in FIG. 36 via a power feed line partially indicated by dashed lines in the figure. The auxiliary controller 919 operates the minimum necessary functions of the smartphone 900, for example, in a sleep mode.

In the smartphone 900 shown in FIG. 36, the wireless communication module 35 of FIG. 3 may be implemented in the wireless communication interface 913. At least some of these functions may also be implemented in the processor 901 or the auxiliary controller 919.

Note that the smartphone 900 may operate as a wireless AP (software AP) by the processor 901 executing AP functions at the application level. The wireless communication interface 913 may also have wireless AP functions.

Furthermore, the smartphone 900 may include a biometric authentication section (fingerprint authentication, palmprint authentication, voice authentication, blood vessel authentication, face authentication, iris authentication, retina authentication). In that case, the wireless communication interface 913 in which the wireless communication module 35 of FIG. 3 is implemented is configured to receive power supply from the same battery 918 as at least one of the display device 910, the speaker 911, or the biometric authentication section.

Further, in the smartphone 900, information is displayed from at least one of the display device 910 or the speaker 911 on the basis of communication with an external apparatus by the wireless communication interface 913. In that case, the result of synchronization by the present technology may be output, as information, from at least one of the display device 910 or the speaker 911.

### 5. In-Vehicle Apparatus

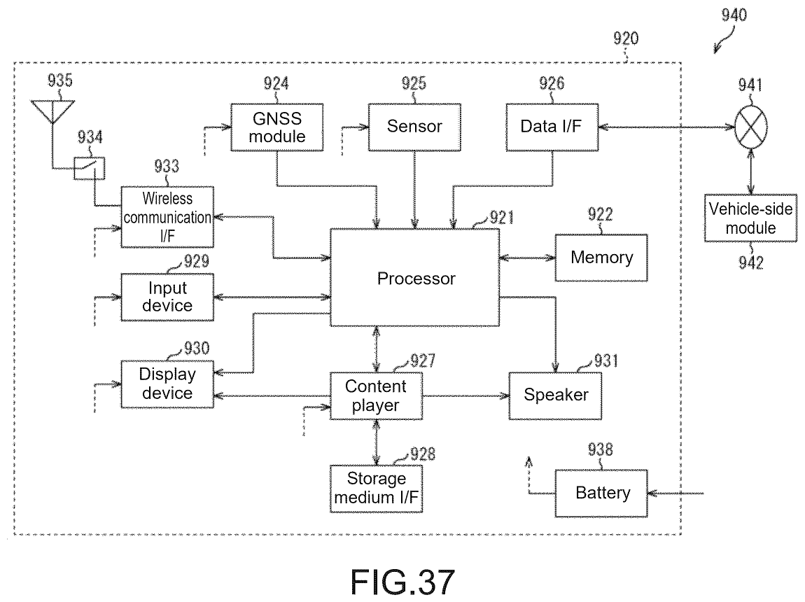

FIG. 37 is a block diagram showing a schematic configuration example of an in-vehicle apparatus 920 to which the present technology is applied.

The in-vehicle apparatus 920 is configured to include a processor 921, a memory 922, a global navigation satellite system (GNSS) module 924, a sensor 925, a data interface 926, a content player 927, and a storage medium interface 928. Further, the in-vehicle apparatus 920 is configured to include an input device 929, a display device 930, a speaker 931, a wireless communication interface 933, an antenna switch 934, an antenna 935, and a battery 938.

The processor 921 may be, for example, a CPU or SoC, and controls the navigation function and other functions of the in-vehicle apparatus 920. Further, the processor 921 can also control the drive system of the vehicle, such as the brake, accelerator, or steering, on the basis of information obtained through communication based on the present technology.

The memory 922 includes a RAM and a ROM, and stores programs and data to be executed by the processor 921.

The GNSS module 924 uses GNSS signals received from GNSS satellites to measure the position (for example, latitude, longitude, and altitude) of the in-vehicle apparatus 920.

The sensor 925 includes a sensor group of, for example, a gyro sensor, a geomagnetic sensor, and a barometric pressure sensor.

The data interface 926 is connected to an in-vehicle network 941, for example, via a terminal not shown in the figure, to acquire data generated by the vehicle, such as in-vehicle data.

The content player 927 reproduces the content stored on a storage medium (for example, CD or DVD) that is inserted into the storage medium interface 928.

The input device 929 includes, for example, a touch sensor that detects touch on the screen of the display device 930, buttons, or switches to accept an operation or information input from the user.

The display device 930 includes a screen such as an LCD or OLED display, and displays images of the navigation function or reproduced content.

The speaker 931 outputs sounds of the navigation function or reproduced content.

Note that in the in-vehicle apparatus 920 the navigation function or the functions by the content player 927 are optional. The navigation function or the content player 927 may be removed from the configuration of the in-vehicle apparatus 920.

The wireless communication interface 933 supports one or more of the wireless LAN standards, such as IEEE802.11a, 11b, 11g, 11n, 11ac, 11ad, 11ax, and 11be and their successor standards, to perform wireless communication. The wireless communication interface 933 communicates with other apparatuses via a wireless LAN AP in an infrastructure mode. Further, the wireless communication interface 933 communicates directly with other apparatuses in the ad hoc mode or a direct communication mode such as Wi-Fi Direct.

The wireless communication interface 933 typically includes a baseband processor, RF circuitry, and a power amplifier. The wireless communication interface 933 may be a single-chip module that integrates a memory that stores a communication control program, a processor that executes the program, and associated circuitry. The wireless communication interface 933 may support, in addition to the wireless LAN method, other types of wireless communication methods such as a short-range wireless communication method, a near field communication method, and a cellular communication method.

The antenna switch 934 switches the connection destination of the antenna 935 between a plurality of circuits included in the wireless communication interface 933.

The antenna 935 includes one or a plurality of antenna elements and is used for transmission and reception of wireless signals by the wireless communication interface 933.

Note that the in-vehicle apparatus 920 is not limited to the example of FIG. 37 and may include a plurality of antennas 935. In such a case, the antenna switch 934 may be omitted from the configuration of the in-vehicle apparatus 920.

The battery 938 supplies power via a power feed line partially indicated by dashed lines in the figure. In the in-vehicle apparatus 920 shown in FIG. 37, the wireless communication module 35 of FIG. 3 may be implemented in the wireless communication interface 933. At least some of these functions may also be implemented in the processor 921.

Further, the wireless communication interface 933 may operate as the non-legacy apparatus 11 or legacy apparatus 12 described above to provide wireless connection to the terminals owned by users in the vehicle.

Further, the present technology may be implemented as an in-vehicle system (or vehicle) 940 that includes one or more blocks of the in-vehicle apparatus 920 described above, the in-vehicle network 941, and a vehicle-side module 942. The vehicle-side module 942 generates vehicle-side data, such as a vehicle speed, an engine RPM, or fault information, and outputs the generated data to the in-vehicle network 941.

### 6. Wireless AP

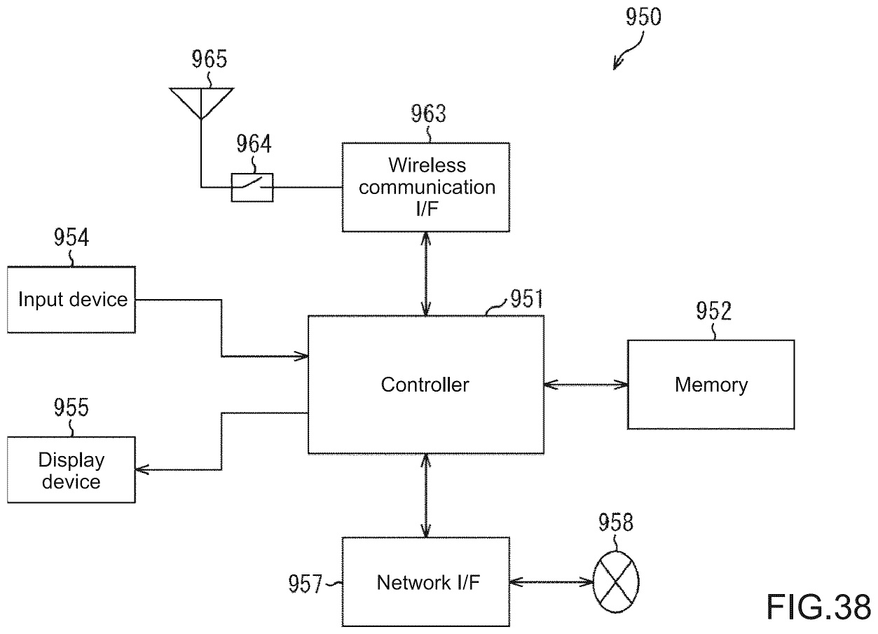

FIG. 38 is a block diagram showing a schematic configuration example of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

The controller 951 may be, for example, a CPU or a digital signal processor (DSP) and operates various functions of the internet protocol (IP) layer and higher layers of the wireless AP 950 (for example, access control, routing, encryption, firewall, and log management).

The memory 952 includes a RAM and a ROM and stores programs to be executed by the controller 951, as well as various types of control data (for example, terminal lists, routing tables, encryption keys, security settings, and logs).

The input device 954 includes, for example, buttons and switches to accept an operation from the user.

The display device 955 includes an LED lamp or the like and displays an operation status of the wireless AP 950.

The network interface 957 is a wired communication interface for the wireless AP 950 to connect to a wired communication network 958. The network interface 957 may include a plurality of connection terminals. The wired communication network 958 may be a LAN such as Ethernet (registered trademark) or a wide area network (WAN).

The wireless communication interface 963 supports one or more of the wireless LAN standards, such as IEEE802.11a, 11b, 11g, 11n, 11ac, 11ad, 11ax, and 11be and their successor standards, to provide wireless communication as the AP for nearby terminals.

The wireless communication interface 963 typically includes a baseband processor, RF circuitry, and a power amplifier.

The wireless communication interface 963 may be a single-chip module that integrates a memory that stores a communication control program, a processor that executes the program, or associated circuitry.

The antenna switch 964 switches the connection destination of the antenna 965 between a plurality of circuits included in the wireless communication interface 963. The antenna 965 includes one or a plurality of antenna elements and is used for transmission and reception of wireless signals by the wireless communication interface 963.

In the wireless AP 950 shown in FIG. 38, the wireless communication module 35 of FIG. 3 may be implemented in the wireless communication interface 963. At least some of these functions may also be implemented in the controller 951.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The embodiments of the present technology are not limited to the embodiments described above, and can be variously modified without departing from the spirit of the present technology.

For example, it is possible to adopt the mode in which all or some of the plurality of embodiments described above are mixed.

For example, the present technology can have a configuration of cloud computing in which a single function is shared and cooperatively processed by a plurality of apparatuses through a network.

Further, the steps described in the flowcharts described above can be executed by one apparatus or shared and executed by a plurality of apparatuses.

Furthermore, in the case where one step includes a plurality of processing steps, the plurality of processing steps in one step can be executed by one apparatus or shared and executed by a plurality of apparatuses.

Note that the effects described herein are merely exemplary ones and are not restrictive ones, and any other effects may be produced.

The present technology can have the following configurations.
(1) A wireless communication control apparatus, including
   a transmission controller that controls transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.
(2) The wireless communication control apparatus according to (1), in which
   the frame is a MAC frame in which both the legacy information and the non-legacy information are disposed, and
   a bit string indicating a signal delimitation position is configured to be disposed between the legacy information and the non-legacy information.
(3) The wireless communication control apparatus according to (1), in which
   the frame is configured such that one preamble, the legacy information, and the non-legacy information are disposed in the frame.
(4) The wireless communication control apparatus according to (1), in which
   the frame is configured such that a legacy portion and a non-legacy portion are concatenated and disposed in the frame via an interval shorter than a predetermined period, the legacy portion including a first preamble and the legacy information, the non-legacy portion including a second preamble and the non-legacy information.
(5) The wireless communication control apparatus according to (1), in which
   the frame is configured to be a frame obtained by concatenating a legacy frame in which a first preamble, a first header, and the legacy information are disposed, and a non-legacy frame in which a second preamble, a second header, and the non-legacy information are disposed, via a predetermined interval.
(6) The wireless communication control apparatus according to (1), in which
   the frame is configured to be a frame obtained by multiplexing a frame of a main channel in which the legacy information is disposed and a frame of a sub-channel in which the non-legacy information is disposed.
(7) The wireless communication control apparatus according to any one of (1) to (6), in which
   the transmission controller is configured to control transmission of data, and
   the non-legacy information is configured to be allocation information that indicates resource allocation for the data.
(8) The wireless communication control apparatus according to any one of (1) to (7), in which
   the legacy information is configured to be information included in a request-to-send (RTS) frame or a clear-to-send (CTS) frame.
(9) A wireless communication control method, including
   a transmission control step of controlling, by a wireless communication control apparatus, transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.
(10) A program for causing a computer to function as a wireless communication control apparatus including
   a transmission controller that controls transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.
(11) A wireless communication control apparatus, including
   a reception controller that controls reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.
(12) The wireless communication control apparatus according to (11), in which
   the frame is a MAC frame in which both the legacy information and the non-legacy information are disposed, and
   a bit string indicating a signal delimitation position is configured to be disposed between the legacy information and the non-legacy information.
(13) The wireless communication control apparatus according to (11), in which
   the frame is configured such that one preamble, the legacy information, and the non-legacy information are disposed in the frame.
(14) The wireless communication control apparatus according to (11), in which
   the frame is configured such that a legacy portion and a non-legacy portion are concatenated and disposed in the frame via an interval shorter than a predetermined period, the legacy portion including a first preamble and the legacy information, the non-legacy portion including a second preamble and the non-legacy information.
(15) The wireless communication control apparatus according to (11), in which
   the frame is configured to be a frame obtained by concatenating a legacy frame in which a first preamble, a first header, and the legacy information are disposed, and a non-legacy frame in which a second preamble, a second header, and the non-legacy information are disposed, via a predetermined interval.
(16) The wireless communication control apparatus according to (11), in which
   the frame is configured to be a frame obtained by multiplexing a frame of a main channel in which the legacy information is disposed and a frame of a sub-channel in which the non-legacy information is disposed.
(17) The wireless communication control apparatus according to any one of (11) to (16), in which
   the reception controller is configured to control reception of data, and
   the non-legacy information is configured to be allocation information that indicates resource allocation for the data.
(18) The wireless communication control apparatus according to any one of (11) to (17), in which
   the legacy information is configured to be information included in a request-to-send (RTS) frame or a clear-to-send (CTS) frame.
(19) A wireless communication control method, including
   a reception control step of controlling, by a wireless communication control apparatus, reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.
(20) A program for causing a computer to function as a wireless communication control apparatus including
   a reception controller that controls reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

### REFERENCE SIGNS LIST

35 wireless communication module
57 transmission controller
60 reception controller

1. A wireless communication control apparatus, comprising
a transmission controller that controls transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

2. The wireless communication control apparatus according to claim 1, wherein
the frame is a MAC frame in which both the legacy information and the non-legacy information are disposed, and
a bit string indicating a signal delimitation position is configured to be disposed between the legacy information and the non-legacy information.

3. The wireless communication control apparatus according to claim 1, wherein
the frame is configured such that one preamble, the legacy information, and the non-legacy information are disposed in the frame.

4. The wireless communication control apparatus according to claim 1, wherein
the frame is configured such that a legacy portion and a non-legacy portion are concatenated and disposed in the frame via an interval shorter than a predetermined period, the legacy portion including a first preamble and the legacy information, the non-legacy portion including a second preamble and the non-legacy information.

5. The wireless communication control apparatus according to claim 1, wherein
the frame is configured to be a frame obtained by concatenating a legacy frame in which a first preamble, a first header, and the legacy information are disposed, and a non-legacy frame in which a second preamble, a second header, and the non-legacy information are disposed, via a predetermined interval.

6. The wireless communication control apparatus according to claim 1, wherein
the frame is configured to be a frame obtained by multiplexing a frame of a main channel in which the legacy information is disposed and a frame of a sub-channel in which the non-legacy information is disposed.

7. The wireless communication control apparatus according to claim 1, wherein
the transmission controller is configured to control transmission of data, and
the non-legacy information is configured to be allocation information that indicates resource allocation for the data.

8. The wireless communication control apparatus according to claim 1, wherein
the legacy information is configured to be information included in a request-to-send (RTS) frame or a clear-to-send (CTS) frame.

9. A wireless communication control method, comprising
a transmission control step of controlling, by a wireless communication control apparatus, transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

10. A program for causing a computer to function as a wireless communication control apparatus comprising
a transmission controller that controls transmission of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

11. A wireless communication control apparatus, comprising
a reception controller that controls reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

12. The wireless communication control apparatus according to claim 11, wherein
the frame is a MAC frame in which both the legacy information and the non-legacy information are disposed, and
a bit string indicating a signal delimitation position is configured to be disposed between the legacy information and the non-legacy information.

13. The wireless communication control apparatus according to claim 11, wherein
the frame is configured such that one preamble, the legacy information, and the non-legacy information are disposed in the frame.

14. The wireless communication control apparatus according to claim 11, wherein
the frame is configured such that a legacy portion and a non-legacy portion are concatenated and disposed in the frame via an interval shorter than a predetermined period, the legacy portion including a first preamble and the legacy information, the non-legacy portion including a second preamble and the non-legacy information.

15. The wireless communication control apparatus according to claim 11, wherein
the frame is configured to be a frame obtained by concatenating a legacy frame in which a first preamble, a first header, and the legacy information are disposed, and a non-legacy frame in which a second preamble, a second header, and the non-legacy information are disposed, via a predetermined interval.

16. The wireless communication control apparatus according to claim 11, wherein
the frame is configured to be a frame obtained by multiplexing a frame of a main channel in which the legacy information is disposed and a frame of a sub-channel in which the non-legacy information is disposed.

17. The wireless communication control apparatus according to claim 11, wherein
the reception controller is configured to control reception of data, and
the non-legacy information is configured to be allocation information that indicates resource allocation for the data.

18. The wireless communication control apparatus according to claim 11, wherein
the legacy information is configured to be information included in a request-to-send (RTS) frame or a clear-to-send (CTS) frame.

19. A wireless communication control method, comprising
a reception control step of controlling, by a wireless communication control apparatus, reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.

20. A program for causing a computer to function as a wireless communication control apparatus comprising
a reception controller that controls reception of a frame in which legacy information for a legacy apparatus and non-legacy information for a non-legacy apparatus are disposed in association with each other, the legacy apparatus being a wireless communication apparatus that is unable to interpret a predetermined type of MAC frame, the non-legacy apparatus being a wireless communication apparatus that is able to interpret the predetermined type of MAC frame.
